(19) United States
(12) Patent Application Publication
(10) Pub. No.: US 2025/0068172 A1
(43) Pub. Date: Feb. 27, 2025

(54) MAP CREATION SYSTEM AND ROUTE PLANNING SYSTEM

(71) Applicant: Kubota Corporation, Osaka (JP)

(72) Inventor: Kenji TAMATANI, Sakai-shi (JP)

(21) Appl. No.: 18/940,979

(22) Filed: Nov. 8, 2024

Related U.S. Application Data
(63) Continuation of application No. PCT/JP2022/043141, filed on Nov. 22, 2022.

(30) Foreign Application Priority Data
May 13, 2022 (JP) 2022-079354

(51) Int. Cl. G05D 1/246; G05D 1/248; G05D 1/646; G05D 107/13

(52) U.S. Cl. CPC G05D 1/246; G05D 1/248; G05D 1/646; G05D 2107/13

(57) ABSTRACT

A map data generation system includes a storage to store map data for an agricultural machine that performs self-driving, and a processor. When data of a road is not included in a predetermined region indicated by the map data, the processor is configured or programmed to generate data of the road in the predetermined region based on a trajectory of a vehicle including a GNSS receiver and traveling in the predetermined region, the trajectory being acquired in the predetermined region based on GNSS data that is output from the GNSS receiver, and attribute information of the vehicle.

### CROSS REFERENCE TO RELATED APPLICATIONS

This application claims the benefit of priority to Japanese Patent Application No. 2022-079354 filed on May 13, 2022 and is a Continuation Application of PCT Application No. PCT/JP2022/043141 filed on Nov. 22, 2022. The entire contents of each application are hereby incorporated herein by reference.

### BACKGROUND OF THE INVENTION

### 1. Field of the Invention

The present disclosure relates to map data generation systems to generate map data for agricultural machines that perform self-driving, and path planning systems each including such map data generation systems.

### 2. Description of the Related Art

Research and development has been directed to the automation of agricultural machines. For example, work vehicles, such as tractors, combines, and rice transplanters, which automatically travel within fields by utilizing a positioning system, e.g., a GNSS (Global Navigation Satellite System), are coming into practical use. Research and development is also under way for work vehicles which automatically travel not only within fields, but also outside the fields. Japanese Laid-Open Publication No. 2021-029218 discloses a system that causes an unmanned work vehicle to perform self-traveling between two fields that are distant from each other across a road.

### SUMMARY OF THE INVENTION

It is desired to efficiently generate map data for an agricultural machine to perform self-driving.

Example embodiments of the present disclosure provide map data generation systems for efficiently generating map data for agricultural machines that perform self-driving, and path planning systems including such map data generation systems.

A map data generation system according to an example embodiment of the present disclosure includes a storage to store map data for an agricultural machine that performs self-driving, and a processor configured or programmed to, when data of a road is not included in a predetermined region indicated by the map data, generate data of the road in the predetermined region based on a trajectory of a vehicle including a GNSS receiver and traveling in the predetermined region, the trajectory being acquired in the predetermined region based on GNSS data that is output from the GNSS receiver and attribute information of the vehicle.

According to example embodiments of the present disclosure, systems that each efficiently generate a map for an agricultural machine that performs self-driving, and path planning systems including such map data generation systems are provided.

The above and other elements, features, steps, characteristics and advantages of the present invention will become more apparent from the following detailed description of the example embodiments with reference to the attached drawings.

### BRIEF DESCRIPTION OF DRAWINGS

FIG. 1 is a diagram providing an overview of an agriculture management system according to an illustrative example embodiment of the present disclosure.

FIG. 2 is a side view schematically showing an example of a work vehicle and an example of an implement linked to the work vehicle.

FIG. 3 is a block diagram showing an example configuration of the work vehicle and the implement.

FIG. 4 is a conceptual diagram showing an example of a work vehicle performing positioning based on an RTK-GNSS.

FIG. 5 is a diagram showing an example of an operational terminal and an example of operation switches that are provided inside a cabin.

FIG. 6 is a block diagram showing an example of schematic hardware configuration of a management device and a terminal device.

FIG. 7 is a diagram schematically showing an example of a work vehicle automatically traveling along a target path inside a field.

FIG. 8 is a flowchart showing an example operation of steering control to be performed during self-driving.

FIG. 9A is a diagram showing an example of a work vehicle traveling along a target path P.

FIG. 9B is a diagram showing an example of a work vehicle at a position which is shifted rightward from the target path P.

FIG. 9C is a diagram showing an example of a work vehicle at a position which is shifted leftward from the target path P.

FIG. 9D is a diagram showing an example of a work vehicle oriented in an inclined direction with respect to the target path P.

FIG. 10 is a diagram schematically showing an example situation where a plurality of work vehicles are self-traveling inside a field and on a road outside the field.

FIG. 11 is a diagram showing an example of a setting screen that is displayed on the terminal device.

FIG. 12 is a diagram showing an example of a schedule of agricultural tasks to be generated by the management device.

FIG. 13A is a diagram showing an example region in which a work vehicle travels.

FIG. 13B is a diagram schematically showing a map of a region in FIG. 13A that is surrounded by broken lines.

FIG. 13C is a schematic diagram for describing a procedure by which a map data generation system generates map data by using the map data of FIG. 13B.

FIG. 13D is a schematic diagram for describing a procedure by which a map data generation system generates map data by using the map data of FIG. 13B.

FIG. 14 is a flowchart showing an example procedure by which a processor generates map data.

FIG. 15A is a diagram showing examples of reception intensities of satellite signals.

FIG. 15B is a diagram showing other examples of reception intensities of satellite signals.

FIG. 16 is a diagram showing an example of a global path and a local path that are generated in an environment in which an obstacle exists.

FIG. 17 is a flowchart showing a method of path planning and travel control.

### DETAILED DESCRIPTION OF THE EXAMPLE EMBODIMENTS

In the present disclosure, an “agricultural machine” refers to a machine for agricultural applications. Examples of agricultural machines include tractors, harvesters, rice transplanters, vehicles for crop management, vegetable transplanters, mowers, seeders, spreaders, and mobile robots for agriculture. Not only may a work vehicle such as a tractor function as an “agricultural machine” alone by itself, but also a combination of a work vehicle and an implement that is attached to, or towed by, the work vehicle may function as an “agricultural machine”. For the ground surface inside a field, the agricultural machine performs agricultural work such as tilling, seeding, preventive pest control, manure spreading, planting of crops, or harvesting. Such agricultural work or tasks may be referred to as “groundwork”, or simply as “work” or “tasks”. Travel of a vehicle-type agricultural machine performed while the agricultural machine also performs agricultural work may be referred to as “tasked travel”.

“Self-driving” refers to controlling the movement of an agricultural machine by the action of a controller, rather than through manual operations of a driver. An agricultural machine that performs self-driving may be referred to as a “self-driving agricultural machine” or a “robotic agricultural machine”. During self-driving, not only the movement of the agricultural machine, but also the operation of agricultural work (e.g., the operation of the implement) may be controlled automatically. In the case where the agricultural machine is a vehicle-type machine, travel of the agricultural machine via self-driving will be referred to as “self-traveling”. The controller may be configured or programmed to control at least one of steering that is required in the movement of the agricultural machine, adjustment of the moving speed, or beginning and ending of a move. In the case of controlling a work vehicle having an implement attached thereto, the controller may control raising or lowering of the implement, beginning and ending of an operation of the implement, and so on. A move based on self-driving may include not only moving of an agricultural machine that goes along a predetermined path toward a destination, but also moving of an agricultural machine that follows a target of tracking. An agricultural machine that performs self-driving may also move partly based on the user's instructions. Moreover, an agricultural machine that performs self-driving may operate not only in a self-driving mode but also in a manual driving mode, where the agricultural machine moves through manual operations of the driver. When performed not manually but through the action of a controller, the steering of an agricultural machine will be referred to as “automatic steering”. A portion of, or an entirety of, the controller may be located outside the agricultural machine. Control signals, commands, data, etc., may be communicated between the agricultural machine and a controller located outside the agricultural machine. An agricultural machine that performs self-driving may move autonomously while sensing the surrounding environment, without any person being involved in the controlling of the movement of the agricultural machine. An agricultural machine that is capable of autonomous movement is able to travel inside the field or outside the field (e.g., on roads) in an unmanned manner. During an autonomous move, operations of detecting and avoiding obstacles may be performed.

A “work plan” is data defining a plan of one or more tasks of agricultural work to be performed by an agricultural machine. The work plan may include, for example, information representing the order of the tasks of agricultural work to be performed by an agricultural machine or the field where each of the tasks of agricultural work is to be performed. The work plan may include information of the date and the time when each of the tasks of agricultural work is to be performed. A work plan including information of the date and time tasks of agricultural work are planned to be performed may referred to as a “task schedule” or simply as a “schedule” in particular. A task schedule may include information of a scheduled start time and/or a scheduled end time of each task of agricultural work to be performed on each work day. For each task of agricultural work, the work plan or task schedule may include information of the content of work, the implement used, and/or the type and amount of agricultural material used, etc. As used herein, “agricultural materials” refer to supply to be used in the agricultural work performed by an agricultural machine. An agricultural material my simply be referred to as a “material”. Agricultural materials may include supplies to be consumed in agricultural work, such as agrochemicals, fertilizers, seeds, seedlings, etc., for example. The work plan may be generated by a processor communicating with the agricultural machine to manage the agricultural work, or a processor mounted on the agricultural machine. The processor can be configured or programmed to generate a work plan based on, for example, information input by the user (farm manager, agricultural worker, etc.) manipulating a terminal device. In the present specification, a processor communicating with the agricultural machine to manage the agricultural work will be referred to as a “management device”. The management device may manage agricultural work of a plurality of agricultural machines. In this case, the management device may generate a work plan including information on each task of agricultural work to be performed by each of the plurality of agricultural machines. The work plan may be downloaded to each agricultural machine and stored in a storage. In order to perform the scheduled agricultural work in accordance with the work plan, each agricultural machine can automatically move to a field and perform the agricultural work.

An “environment map” is data representing, with a predetermined coordinate system, the position or the region of an object existing in the environment where the agricultural machine moves. The environment map may be referred to simply as a “map” or “map data”. The coordinate system defining the environment map is, for example, a world coordinate system such as a geographic coordinate system fixed to the globe. Regarding an object existing in the environment, the environment map may include information other than the position (e.g., attribute information or other types of information). The “environment map” encompasses various type of maps such as a point cloud map and a grid map. Data on a local map or a partial map that is generated or processed in a process of constructing the environment map is also referred to as a “map” or “map data”.

An “agricultural road” is a road used mainly for agriculture. An “agricultural road” is not limited to a road paved with asphalt, and encompasses unpaved roads covered with soil, gravel or the like. An “agricultural road” encompasses roads (including private roads) on which only vehicle-type agricultural machines (e.g., work vehicles such as tractors, etc.) are allowed to travel and roads on which general vehicles (cars, trucks, buses, etc.) are also allowed to travel. The work vehicles may automatically travel on a general road in addition to an agricultural road. The “general road” is a road maintained for traffic of general vehicles.

“Geographic features” mean things on the ground. Examples of geographic features include channels, grasses, trees, roads, fields, trenches, rivers, bridges, woods, mountains, rocks, buildings, railroad tracks, and so on. Things that do not exist in the real world, e.g., border lines, names of places, building names, field names, and route names, are not included among the “geographic features” in the present disclosure.

A “GNSS satellite” means an artificial satellite in a Global Navigation Satellite System (GNSS). GNSS is a collective term for satellite positioning systems such as the GPS (Global Positioning System), QZSS (Quasi-Zenith Satellite System), GLONASS, Galileo, and BeiDou. GNSS satellites are satellites in these positioning systems. A signal transmitted from a GNSS satellite is called a “satellite signal”. A “GNSS receiver” is a device that receives radio waves transmitted from a plurality of satellites in a GNSS and performs positioning based on signals superposed on the radio waves. “GNSS data” is data that is output from a GNSS receiver, which may be generated in a predetermined format such as NMEA-0183 format, etc. GNSS data may include, for example, information indicating the reception statuses of satellite signals received from individual satellites. For example, GNSS data can include values indicating the ID number, angle of elevation, azimuth angle, and reception intensity of each satellite from which a satellite signal was received. Reception intensity is a numerical value indicating the intensity of a received satellite signal. Reception intensity can be expressed in values such as Carrier to Noise Density Ratio (C/NO). GNSS data can include positional information of the GNSS receiver or agricultural machine as calculated based on a plurality of received satellite signals. The positional information can be expressed by latitude, longitude, and height above mean sea level, etc., for example. GNSS data may further include information indicating the reliability of the positional information.

That “satellite signals can be properly received” means that it is possible to receive satellite signals stably enough for not significantly degrading positioning reliability. A state where satellite signals cannot be properly received may be expressed as “reception problems for satellite signals” being present. “Reception problems for satellite signals” are a condition in which the reception status of satellite signals deteriorates, thus resulting in a decreased positioning reliability as compared to the normal condition. Reception problems may occur, for example, when the number of detected satellites is small (e.g., 3 or less), when the reception intensity of each satellite signal is low, or when a multipath is occurring. Whether or not reception problems are present can be determined based on information concerning satellites that is included in the GNSS data, for example. For example, the presence or absence of reception problems can be determined based on the value of reception intensity for each satellite that is included in the GNSS data, or DOP (Dilution of Precision) values that indicate a deployment status of satellites.

A “global path” means data of a path of an agricultural machine when automatically moving from a departure point to a destination point, the data being generated by a processor that performs path planning. Generation of a global path is referred to as global path planning. In the following description, a global path is referred to as a “target path” or simply as a “path”. A global path may be defined by the coordinate values of a plurality of points for an agricultural machine to pass through, for example. A point for an agricultural machine to pass through is referred to as a “waypoint”, whereas a line segment connecting adjacent waypoints is referred to as a “link”.

A “local path” means a locally-present path that allows for avoiding an obstacle, such a path being consecutively generated when an agricultural machine automatically moves along a global path. Generation of a local path is referred to as local path planning. While an agricultural machine is moving, local paths are consecutively generated based on data that is acquired by one or more sensing devices included in the agricultural machine. A local path may be defined by a plurality of waypoints along a portion of a global path. However, when an obstacle exists near the global path, waypoints may be set so as to detour around that obstacle. The length of a link between waypoints of a local path is shorter than the length of a link between waypoints of a global path. The device that generates local paths may be the same as or different from the device that generates global paths. For example, a management device to manage the agricultural work by an agricultural machine may generate global paths, and a controller mounted on the agricultural machine may generate local paths. In that case, a combination of the management device and the controller functions as a “processor” that performs path planning. The controller of the agricultural machine may be configured or programmed to function as a processor to perform both of global path planning and local path planning.

A “storage location” is a place that is provided for storing an agricultural machine. The storage location may be, for example, a place that is managed by a user, or a place that is jointly operated by a plurality of users, of an agricultural machine. The storage location may be a place that is set aside for storing an agricultural machine, in the home or office of the user(s) (agricultural worker(s), etc.), e.g., a warehouse, a barn, or a parking space. The position of the storage location may be previously registered, and recorded in a storage.

A “standby location” is a place provided for an agricultural machine to stand by while not performing agricultural work. One or more standby locations may be provided within an environment where the agricultural machine performs self-driving. The aforementioned storage location is an example of a standby location. A standby location may be a place that is jointly managed or used by a plurality of users. Standby locations may be warehouses, garages, barns, parking spaces, or other facilities, for example. A standby location may be a warehouse, a barn, a garage, or a parking space at the home or office of an agricultural worker other than the user(s) of the agricultural machine. A plurality of standby locations may exist within an environment in which the agricultural machine moves. Work may be performed at a standby location, such as the exchange or maintenance of parts of the agricultural machine or an implement, or replenishment of materials, etc. In that case, parts, tools, or materials that are necessary for such work may be placed at the standby location.

Hereinafter, example embodiments of the present disclosure will be described. Note however that unnecessarily detailed descriptions may be omitted. For example, detailed descriptions of what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand example embodiments of the present disclosure, are not intended to limit the scope of claims. In the following description, component elements having identical or similar functions are denoted by identical reference numerals.

General or specific example embodiments of the present disclosure may be implemented using a device, a system, a method, an integrated circuit, a computer program, a non-transitory computer-readable storage medium, or any combination thereof. The computer-readable storage medium may be inclusive of a volatile storage medium, or a non-volatile storage medium. The device may include a plurality of devices. In the case where the device includes two or more devices, the two or more devices may be disposed within a single apparatus, or divided over two or more separate apparatuses.

The following example embodiments are only exemplary, and the techniques according to example embodiments of the present disclosure are not limited to the following example embodiments. For example, numerical values, shapes, materials, steps, and orders of steps, layout of a display screen, etc., that are indicated in the following example embodiments are only exemplary, and admit of various modifications so long as it makes technological sense. Any one implementation may be combined with another so long as it makes technological sense to do so.

Hereinafter, example embodiments in which techniques according to the present disclosure are applied to work vehicles, such as tractors, which are examples of agricultural machines, will be mainly described. The techniques according to example embodiments of the present disclosure are also applicable to other types of agricultural machines, in addition to work vehicles such as tractors.

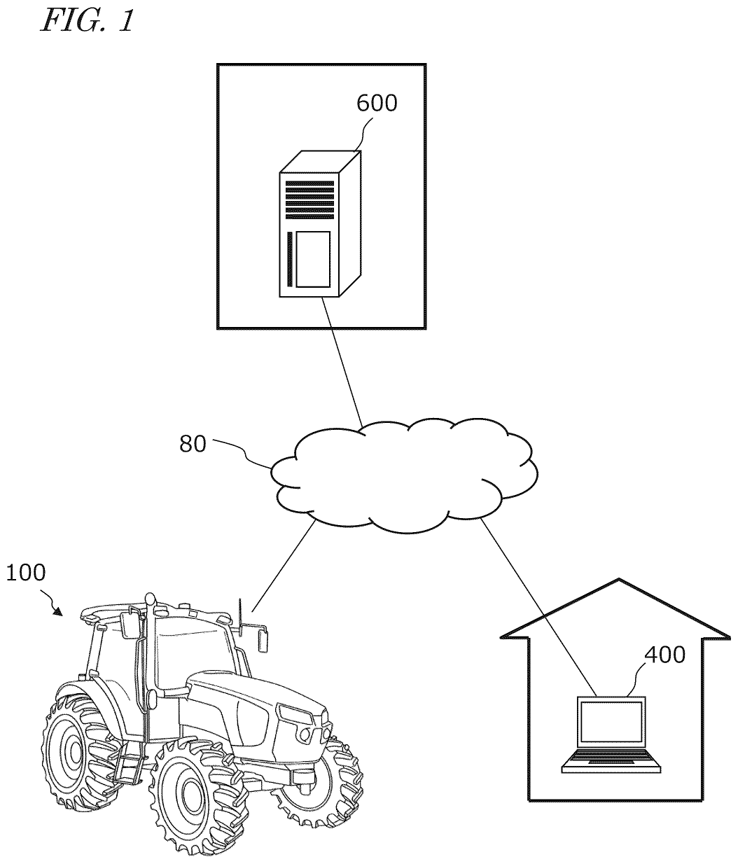

FIG. 1 is a diagram providing an overview of an agriculture management system according to an illustrative example embodiment of the present disclosure. The agriculture management system shown in FIG. 1 includes a work vehicle 100, a terminal device 400, and a management device 600. The terminal device 400 is a computer used by a user performing remote monitoring of the work vehicle 100. The management device 600 is a computer managed by a business operator running the agriculture management system. The work vehicle 100, the terminal device 400, and the management device 600 can communicate with one another via the network 80. Although FIG. 1 illustrates one work vehicle 100, the agriculture management system may include a plurality of the work vehicles or any other agricultural machine.

The work vehicle 100 according to the present example embodiment is a tractor. The work vehicle 100 can have an implement attached to its rear and/or its front. While performing agricultural work in accordance with a particular type of implement, the work vehicle 100 is able to travel inside a field. The work vehicle 100 may travel inside the field or outside the field with no implement being attached thereto.

The work vehicle 100 has a self-driving function. In other words, the work vehicle 100 can travel by the action of a controller, rather than manually. The controller according to the present example embodiment is provided inside the work vehicle 100, and is able to control both the speed and steering of the work vehicle 100. The work vehicle 100 can perform self-traveling outside the field (e.g., on roads) as well as inside the field.

The work vehicle 100 includes a device usable for positioning or localization, such as a GNSS receiver or a LiDAR sensor. Based on the position of the work vehicle 100 and information on a target path generated by the management device 600, the controller of the work vehicle 100 causes the work vehicle 100 to automatically travel. In addition to controlling the travel of the work vehicle 100, the controller also controls the operation of the implement. As a result, while automatically traveling inside the field, the work vehicle 100 is able to perform agricultural work by using the implement. In addition, the work vehicle 100 is able to automatically travel along a target path on a road outside the field (e.g., an agricultural road or a general road). When performing self-traveling along a road outside the field, the work vehicle 100 travels along a target path while generating local paths that allow for avoiding obstacles, based on data that is output from a sensing device, such as a camera or a LiDAR sensor. Inside the field, the work vehicle 100 may travel while generating local paths similarly to the above, or perform an operation of traveling along a target path without generating local paths, and stopping upon detection of an obstacle.

The management device 600 is a computer to manage the agricultural work performed by the work vehicle 100. The management device 600 may be, for example, a server computer that performs centralized management of information regarding the field on a cloud and assists in agriculture by using data on the cloud. The management device 600 may, for example, generate a work plan for the work vehicle 100, and in accordance with the work plan, generate a target path for the work vehicle 100. Alternatively, the management device 600 may generate a target path for the work vehicle 100 in response to the user's operation via the terminal device 400. Hereinafter, unless otherwise specified, a target path for the work vehicle 100 generated by the management device 600 (i.e., a global path) will simply be referred to as a “path”.

The management device 600 includes a storage and a processor. The storage stores map data for the work vehicle 100 to perform self-driving. Based on a trajectory of a vehicle including a GNSS receiver in a predetermined region indicated by the map data, the trajectory being acquired based on GNSS data that is output from the GNSS receiver when the vehicle travels in the predetermined region, and also on attribute information of the vehicle, the processor generates data of a road in the predetermined region. Through such processing, as will be described below in detail, a map for the work vehicle 100 that performs self-driving can be efficiently generated.

Depending on whether it is inside the field or outside the field, the management device 600 generates a target path with a different method. The management device 600 generates a target path inside the field based on information concerning the field. For example, the management device 600 can generate a target path inside the field based on various information, e.g., outer shape of the field, field area, entrance/exit positions of the field, width of the work vehicle 100, width of the implement, content of work, kind of crop to be cultivated, crop growth area, crop growth status, or intervals between crop rows or ridges, that are previously registered. The management device 600 generates a target path inside the field based on information that is input by the user using the terminal device 400 or other devices, for example. The management device 600 generates a path inside the field so as to cover the entirety of a work area in which tasks are to be performed, for example. On the other hand, the management device 600 generates a target path outside the field in accordance with a work plan or the user's instruction. For example, the management device 600 can generate a target path outside the field based on various information, e.g., order of tasks of agricultural work indicated by the work plan, positions in the field where tasks of agricultural work are to be performed, entrance/exit positions in the field, a scheduled start time and a scheduled end time of each task of agricultural work, attribute information of each road recorded in the map, state of the road surface, weather status, or traffic status. Regardless of the work plan, the management device 600 may generate a target path based on information indicating a path or a waypoint(s) designated by the user through operation of the terminal device 400.

In addition, the management device 600 may generate or edit an environment map based on data collected by the work vehicle 100 or any other movable unit by using the sensing device such as a LiDAR sensor. The management device 600 transmits data on the work plan, the target path, and the environment map thus generated to the work vehicle 100. The work vehicle 100 automatically moves and performs agricultural work based on these data.

Note that the global path planning and generation (or editing of) the environment map may be performed by not only the management device 600 but also any other device. For example, the controller of the work vehicle 100 may perform global path planning or generation or editing of the environment map.

The terminal device 400 is a computer that is used by a user who is at a remote place from the work vehicle 100. Although the terminal device 400 shown in FIG. 1 is a laptop computer, the terminal device 400 is not limited to this. The terminal device 400 may be a stationary computer such as a desktop PC (personal computer), or a mobile terminal such as a smartphone or a tablet computer. The terminal device 400 may be used to perform remote monitoring of the work vehicle 100 or remote-manipulate the work vehicle 100. For example, the terminal device 400 can indicate, on a display thereof, a video captured by one or more cameras (imagers) included in the work vehicle 100. By looking at the video, the user is able to check the status of the surroundings of the work vehicle 100, and send an instruction to the work vehicle 100 to halt or pull out. The terminal device 400 can also indicate, on the display thereof, a setting screen allowing the user to input information necessary to generate a work plan (e.g., a schedule of tasks of agricultural work) for the work vehicle 100. When the user inputs necessary information to the setting screen and performs an operation to transmit the information, the terminal device 400 transmits the input information to the management device 600. The management device 600 generates a work plan based on the information. The terminal device 400 may further have a function of indicating, on the display thereof, a setting screen allowing the user to input information necessary to set a target path. The terminal device 400 may also be used to register one or more fields in which the work vehicle 100 is to perform agricultural work, a storage location for the work vehicle 100, and one or more standby locations in which the work vehicle 100 is to temporarily stand by.

Hereinafter, a configuration and an operation of the system according to the present example embodiment will be described in more detail.

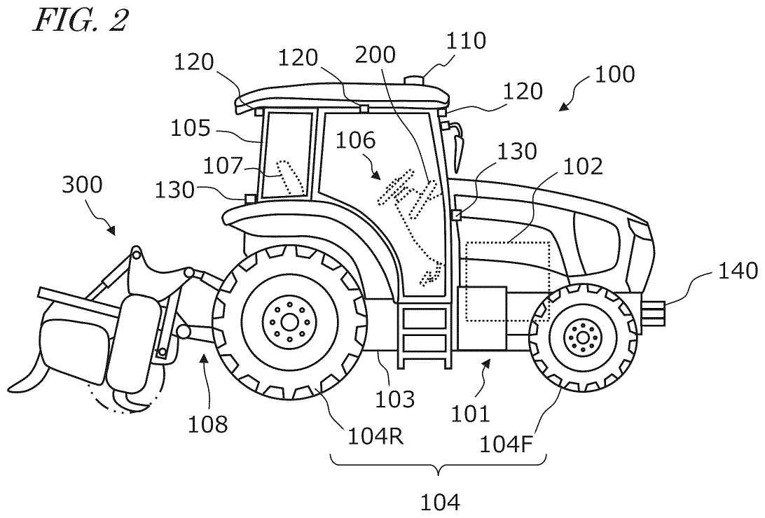

FIG. 2 is a side view schematically showing an example of the work vehicle 100 and an example of an implement 300 linked to the work vehicle 100. The work vehicle 100 according to the present example embodiment can operate both in a manual driving mode and a self-driving mode. In the self-driving mode, the work vehicle 100 is able to perform unmanned travel. The work vehicle 100 can perform self-driving both inside a field and outside the field.

As shown in FIG. 2, the work vehicle 100 includes a vehicle body 101, a prime mover (engine) 102, and a transmission 103. On the vehicle body 101, wheels 104 with tires and a cabin 105 are provided. The wheels 104 include a pair of front wheels 104F and a pair of rear wheels 104R. Inside the cabin 105, a driver's seat 107, a steering device 106, an operational terminal 200, and switches for operation are provided. In the case where the work vehicle 100 performs tasked travel inside the field, the front wheels 104F and/or the rear wheels 104R may be replaced by a plurality of wheels with a track (crawlers); rather than wheels with tires, attached thereto.

The work vehicle 100 includes at least one sensing device to sense the surrounding environment of the work vehicle 100. In the example shown in FIG. 2, the work vehicle 100 includes a plurality of sensing devices. The sensing devices include a plurality of cameras 120, a LiDAR sensor 140, and a plurality of obstacle sensors 130.

The cameras 120 may be provided at the front/rear/right/left of the work vehicle 100, for example. The cameras 120 image the surrounding environment of the work vehicle 100 and generate image data. The images acquired with the cameras 120 may be transmitted to the terminal device 400, which is responsible for remote monitoring. The images may be used to monitor the work vehicle 100 during unmanned driving. The cameras 120 may also be used to generate images to allow the work vehicle 100, traveling on a road outside the field (an agricultural road or a general road), to recognize geographic features, obstacles, white lines, road signs, indications or the like in the surroundings.

The LiDAR sensor 140 in the example shown in FIG. 2 is disposed on a lower portion of a front face of the vehicle body 101. The LiDAR sensor 140 may be disposed at any other position. For example, the LiDAR sensor 140 may be disposed on an upper portion of the cabin 105. The LiDAR sensor 140 may be a 3D-LiDAR sensor, but may also be a 2D-LiDAR sensor. The LiDAR sensor 140 senses the surrounding environment of the work vehicle 100 and outputs sensor data. While the work vehicle 100 is traveling, the LiDAR sensor 140 repeatedly outputs sensor data representing the distances and directions of measurement points on objects existing in the surrounding environment, or two-dimensional or three-dimensional coordinate values of such measurement points. The sensor data that is output from the LiDAR sensor 140 is processed by the controller of the work vehicle 100. The controller can perform localization of the work vehicle 100 by matching the sensor data against the environment map. The controller can further detect an object such as an obstacle existing in the surroundings of the work vehicle 100 based on the sensor data. The controller can utilize an algorithm such as, for example, SLAM (Simultaneous Localization and Mapping) to generate or edit an environment map. The work vehicle 100 may include a plurality of LiDAR sensors disposed at different positions with different orientations.

The plurality of obstacle sensors 130 shown in FIG. 2 are provided at the front and the rear of the cabin 105. The obstacle sensors 130 may be disposed at other positions. For example, one or more obstacle sensors 130 may be disposed at any position at the sides, the front, or the rear of the vehicle body 101. The obstacle sensors 130 may include, for example, laser scanners or ultrasonic sonars. The obstacle sensors 130 may be used to detect obstacles in the surroundings during self-traveling to cause the work vehicle 100 to halt or detour around the obstacles. The LiDAR sensor 140 may be used as one of the obstacle sensors 130.

The work vehicle 100 further includes a GNSS unit 110. The GNSS unit 110 includes a GNSS receiver. The GNSS receiver may include an antenna to receive a signal(s) from a GNSS satellite(s) and a processor configured or programmed to calculate the position of the work vehicle 100 based on the signal(s) received by the antenna. The GNSS unit 110 receives satellite signals transmitted from the plurality of GNSS satellites, and performs positioning based on the satellite signals. GNSS is a collective term for satellite positioning systems such as the GPS (Global Positioning System), QZSS (Quasi-Zenith Satellite System, e.g., MICHIBIKI), GLONASS, Galileo, and BeiDou. Although the GNSS unit 110 according to the present example embodiment is disposed above the cabin 105, it may be disposed at any other position.

The GNSS unit 110 may include an inertial measurement unit (IMU). Signals from the IMU can be used to complement position data. The IMU can measure a tilt or a small motion of the work vehicle 100. The data acquired by the IMU can be used to complement the position data based on the satellite signals, so as to improve the performance of positioning.

The controller of the work vehicle 100 may utilize, for positioning, the sensor data acquired with the sensing devices such as the cameras 120 or the LIDAR sensor 140, in addition to the positioning results provided by the GNSS unit 110. In the case where objects serving as characteristic points exist in the environment that is traveled by the work vehicle 100, as in the case of an agricultural road, a forest road, a general road, or an orchard, the position and the orientation of the work vehicle 100 can be estimated with a high accuracy based on data that is acquired with the cameras 120 or the LiDAR sensor 140 and on an environment map that is previously stored in the storage. By correcting or complementing position data based on the satellite signals using the data acquired with the cameras 120 or the LiDAR sensor 140, it becomes possible to identify the position of the work vehicle 100 with a higher accuracy.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force for changing the steering angle of the front wheels 104F. When automatic steering is performed, under the control of the controller disposed in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point link” or a “three-point hitch”), a PTO (Power Take Off) shaft, a universal joint, and a communication cable. The linkage device 108 allows the implement 300 to be attached to, or detached from, the work vehicle 100. The linkage device 108 is able to raise or lower the three-point link with a hydraulic device, for example, thus changing the position or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided at the front portion of the vehicle body 101. In that case, the implement can be connected at the front portion of the work vehicle 100.

Although the implement 300 shown in FIG. 2 is a rotary tiller, the implement 300 is not limited to a rotary tiller. For example, any arbitrary implement such as a seeder, a spreader, a transplanter, a mower, a rake, a baler, a harvester, a sprayer, or a harrow, can be connected to the work vehicle 100 for use.

The work vehicle 100 shown in FIG. 2 can be driven by human driving; alternatively, it may only support unmanned driving. In that case, component elements which are only required for human driving, e.g., the cabin 105, the steering device 106, and the driver's seat 107 do not need to be provided in the work vehicle 100. An unmanned work vehicle 100 can travel via autonomous driving, or by remote operation by a user.

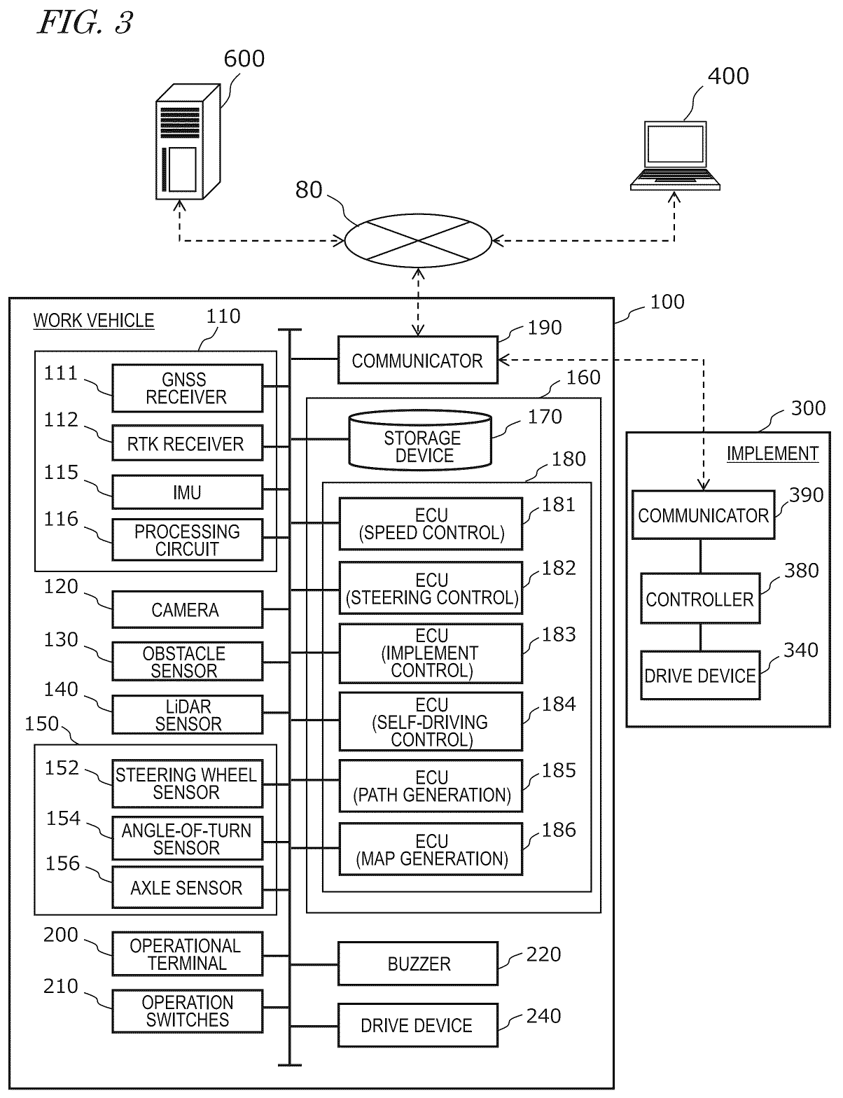

FIG. 3 is a block diagram showing an example configuration of the work vehicle 100 and the implement 300. The work vehicle 100 and the implement 300 can communicate with each other via a communication cable that is included in the linkage device 108. The work vehicle 100 is able to communicate with the terminal device 400 and the management device 600 via the network 80.

In addition to the GNSS unit 110, the cameras 120, the obstacle sensors 130, the LiDAR sensor 140, and the operational terminal 200, the work vehicle 100 in the example of FIG. 3 includes sensors 150 to detect the operating status of the work vehicle 100, a control system 160, a communicator 190, operation switches 210, a buzzer 220, and a drive device 240. These component elements are communicably connected to one another via a bus. The GNSS unit 110 includes a GNSS receiver 111, an RTK receiver 112, an inertial measurement unit (IMU) 115, and a processing circuit 116. The sensors 150 include a steering wheel sensor 152, an angle-of-turn sensor 154, and an axle sensor 156. The control system 160 includes a storage 170 and a controller 180. The controller 180 includes a plurality of electronic control units (ECU) 181 to 186. The implement 300 includes a drive device 340, a controller 380, and a communicator 390. Note that FIG. 3 shows component elements which are relatively closely related to the operations of self-driving by the work vehicle 100, while other components are omitted from illustration.

The GNSS receiver 111 in the GNSS unit 110 receives satellite signals transmitted from the plurality of GNSS satellites and generates GNSS data based on the satellite signals. The GNSS data is generated in a predetermined format such as, for example, the NMEA-0183 format. The GNSS data may include, for example, the ID number, the angle of elevation, the azimuth angle, and a value representing the reception intensity of each of the satellites from which the satellite signals are received. Reception intensity may be expressed by a value such as carrier to noise density ratio (C/NO), for example. GNSS data may include positional information of the work vehicle 100 as calculated based on a plurality of received satellite signals and information indicating the reliability of that positional information. The positional information may be expressed in terms of latitude, longitude, height from the mean sea level, for example. The reliability of positional information may be expressed in terms of a DOP value that indicates the deployment status of the satellites or the like, for example.

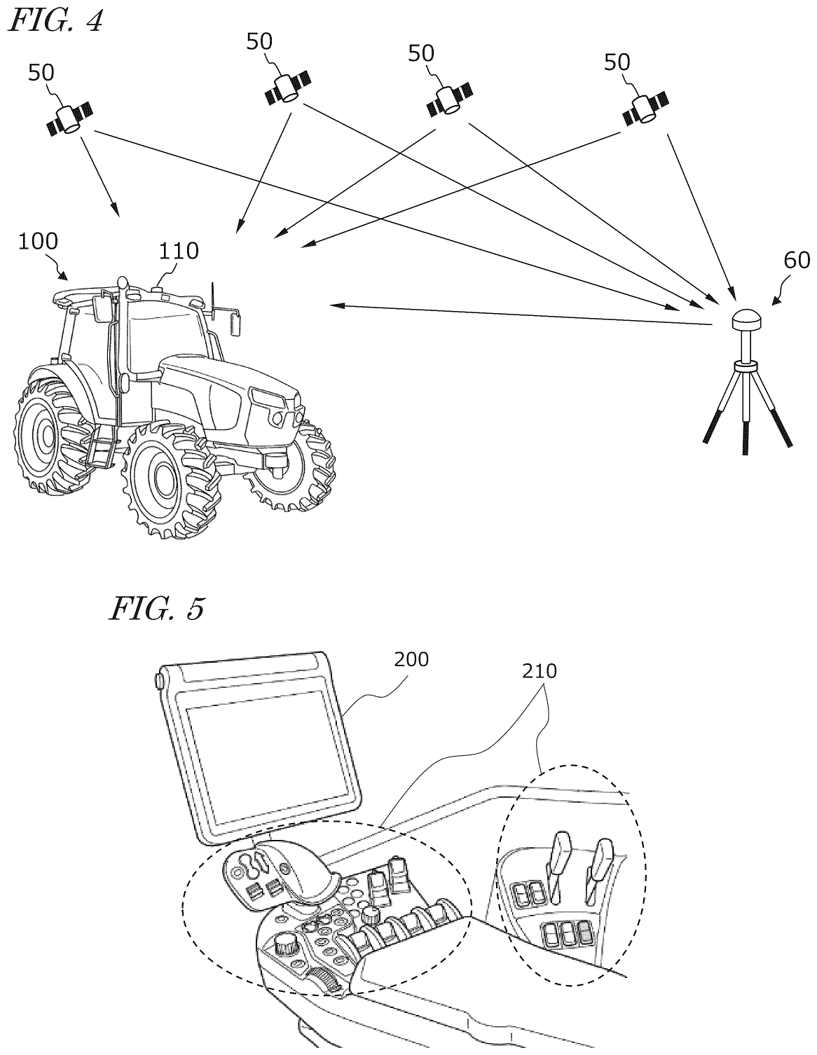

The GNSS unit 110 shown in FIG. 3 performs positioning of the work vehicle 100 by utilizing an RTK (Real Time Kinematic)-GNSS. FIG. 4 is a conceptual diagram showing an example of the work vehicle 100 performing positioning based on the RTK-GNSS. In the positioning based on the RTK-GNSS, not only satellite signals transmitted from a plurality of GNSS satellites 50, but also a correction signal that is transmitted from a reference station 60 is used. The reference station 60 may be disposed near the field where the work vehicle 100 performs tasked travel (e.g., at a position within 10 km of the work vehicle 100). The reference station 60 generates a correction signal of, for example, an RTCM format based on the satellite signals received from the plurality of GNSS satellites 50, and transmits the correction signal to the GNSS unit 110. The RTK receiver 112, which includes an antenna and a modem, receives the correction signal transmitted from the reference station 60. Based on the correction signal, the processing circuit 116 of the GNSS unit 110 corrects the results of the positioning performed by the GNSS receiver 111. Use of the RTK-GNSS enables positioning with an accuracy on the order of several centimeters of errors, for example. Positional information including latitude, longitude, and altitude information is acquired through the highly accurate positioning by the RTK-GNSS. The GNSS unit 110 calculates the position of the work vehicle 100 as frequently as, for example, one to ten times per second.

Note that the positioning method is not limited to being performed by using an RTK-GNSS; any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System). In the case where positional information with the necessary accuracy can be obtained without the use of the correction signal transmitted from the reference station 60, positional information may be generated without using the correction signal. In that case, the GNSS unit 110 does not need to include the RTK receiver 112.

Even in the case where the RTK-GNSS is used, at a place where the correction signal from the reference station 60 cannot be acquired (e.g., on a road far from the field), the position of the work vehicle 100 is estimated by another method with no use of the signal from the RTK receiver 112. For example, the position of the work vehicle 100 may be estimated by matching the data that is output from the LiDAR sensor 140 and/or the cameras 120 against a highly accurate environment map.

The GNSS unit 110 according to the present example embodiment further includes the IMU 115. The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the GNSS unit 110.

The cameras 120 are imagers that image the surrounding environment of the work vehicle 100. Each camera 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image (e.g., motion picture) data. The cameras 120 are able to capture motion pictures at a frame rate of 3 frames/second (fps: frames per second) or greater, for example. The images generated by the cameras 120 may be used by a remote supervisor to check the surrounding environment of the work vehicle 100 with the terminal device 400, for example. The images generated by the cameras 120 may also be used for the purpose of positioning or detection of obstacles. As shown in FIG. 2, the plurality of cameras 120 may be provided at different positions on the work vehicle 100, or a single camera 120 may be provided. A visible camera(s) to generate visible images and an infrared camera(s) to generate infrared images may be separately provided. Both of a visible camera(s) and an infrared camera(s) may be provided as cameras for generating images for monitoring purposes. The infrared camera(s) may also be used for detection of obstacles at nighttime.

The obstacle sensors 130 detect objects existing in the surroundings of the work vehicle 100. Each obstacle sensor 130 may include a laser scanner or an ultrasonic sonar, for example. When an object exists at a position within a predetermined distance from an obstacle sensor 130, the obstacle sensor 130 outputs a signal indicating the presence of the obstacle. The plurality of obstacle sensors 130 may be provided at different positions on the work vehicle 100. For example, a plurality of laser scanners and a plurality of ultrasonic sonars may be disposed at different positions on the work vehicle 100. Providing such a great number of obstacle sensors 130 can reduce blind spots in monitoring obstacles in the surroundings of the work vehicle 100.

The steering wheel sensor 152 measures the angle of rotation of the steering wheel of the work vehicle 100. The angle-of-turn sensor 154 measures the angle of turn of the front wheels 104F, which are the wheels responsible for steering. Measurement values by the steering wheel sensor 152 and the angle-of-turn sensor 154 are usable to perform steering control by the controller 180.

The axle sensor 156 measures the rotational speed, i.e., the number of revolutions per unit time, of an axle that is connected to the wheels 104. The axle sensor 156 may be a sensor including a magnetoresistive element (MR), a Hall generator, or an electromagnetic pickup, for example. The axle sensor 156 outputs a numerical value indicating the number of revolutions per minute (unit: rpm) of the axle, for example. The axle sensor 156 is used to measure the speed of the work vehicle 100.

The drive device 240 includes various types of devices required to cause the work vehicle 100 to travel and to drive the implement 300; for example, the prime mover 102, the transmission 103, the steering device 106, the linkage device 108 and the like described above. The prime mover 102 may include an internal combustion engine such as, for example, a diesel engine. The drive device 240 may include an electric motor for traction instead of, or in addition to, the internal combustion engine.

The buzzer 220 is an audio output device to present an alarm sound for alerting the user of an abnormality. For example, the buzzer 220 may present an alarm sound when an obstacle is detected during self-driving. The buzzer 220 is controlled by the controller 180.

The storage 170 includes one or more storage media such as a flash memory or a magnetic disc. The storage 170 stores various data that is generated by the GNSS unit 110, the cameras 120, the obstacle sensors 130, the LiDAR sensor 140, the sensors 150, and the controller 180. The data that is stored by the storage 170 may include map data on the environment where the work vehicle 100 travels (environment map) and data on global path (target path) for self-driving. The environment map includes information on a plurality of fields where the work vehicle 100 performs agricultural work and roads around the fields. The environment map and the target path may be generated by a processor in the management device 600. The controller 180 may be configured or programmed to perform generating or editing an environment map and a target path. The controller 180 can edit the environment map and the target path, acquired from the management device 600, in accordance with the environment where the work vehicle 100 travels. The storage 170 also stores data on a work plan received by the communicator 190 from the management device 600.

A work plan includes information on a plurality of tasks of agricultural work for the work vehicle 100 to perform over a plurality of work days. The work plan may be data of a task schedule including information on scheduled times of each task of agricultural work to be performed by the work vehicle 100 on each work day, for example.

The storage 170 also stores a computer program(s) to cause each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 may include a plurality of ECUs. The plurality of ECUs include, for example, the ECU 181 configured or programmed to perform speed control, the ECU 182 configured or programmed to perform steering control, the ECU 183 configured or programmed to perform implement control, the ECU 184 configured or programmed to perform self-driving control, the ECU 185 configured or programmed to perform path generation, and the ECU 186 configured or programmed to perform map generation.

The ECU 181 controls the prime mover 102, the transmission 103, and brakes included in the drive device 240, thus controlling the speed of the work vehicle 100.

The ECU 182 controls the hydraulic device or the electric motor included in the steering device 106 based on a measurement value of the steering wheel sensor 152, thus controlling the steering of the work vehicle 100.

In order to cause the implement 300 to perform a desired operation, the ECU 183 controls the operations of the three-point link, the PTO shaft and the like that are included in the linkage device 108. Also, the ECU 183 generates a signal to control the operation of the implement 300, and transmits this signal from the communicator 190 to the implement 300.

Based on data output from the GNSS unit 110, the cameras 120, the obstacle sensors 130, the LiDAR sensor 140, and the sensors 150, the ECU 184 performs computation and control for achieving self-driving. For example, the ECU 184 specifies the position of the work vehicle 100 based on the data output from at least one of the GNSS unit 110, the cameras 120, and the LiDAR sensor 140. Inside the field, the ECU 184 may determine the position of the work vehicle 100 based only on the data output from the GNSS unit 110. The ECU 184 may estimate or correct the position of the work vehicle 100 based on the data acquired with the cameras 120 or the LiDAR sensor 140. Using the data acquired with the cameras 120 or the LiDAR sensor 140 allows the accuracy of the positioning to be further improved. Outside the field, the ECU 184 estimates the position of the work vehicle 100 by using the data output from the LiDAR sensor 140 or the cameras 120. For example, the ECU 184 may estimate the position of the work vehicle 100 by matching the data output from the LiDAR sensor 140 or the cameras 120 against the environment map. During self-driving, the ECU 184 performs computation necessary for the work vehicle 100 to travel along a target path or a local path, based on the estimated position of the work vehicle 100. The ECU 184 sends the ECU 181 a command to change the speed, and sends the ECU 182 a command to change the steering angle. In response to the command to change the speed, the ECU 181 controls the prime mover 102, the transmission 103, or the brakes to change the speed of the work vehicle 100. In response to the command to change the steering angle, the ECU 182 controls the steering device 106 to change the steering angle.

While the work vehicle 100 is traveling along a target path, the ECU 185 consecutively generates local paths that allow for avoiding obstacles. During travel of the work vehicle 100, based on data output from the cameras 120, the obstacle sensors 130, and the LiDAR sensor 140, the ECU 185 recognizes obstacles existing in the surroundings of the work vehicle 100. The ECU 185 generates local paths so as to avoid any recognized obstacle.

The ECU 185 may be configured or programmed to perform global path planning in the place of the management device 600. In that case, the ECU 185 determines a moving destination of the work vehicle 100 based on a work plan stored in the storage 170, and determines a target path from a start point to a destination point of movement of the work vehicle 100. Based on an environment map stored in the storage 170 including road information, the ECU 185 can generate a path that reaches the moving destination in the shortest possible time as a target path, for example. Alternatively, based on the attribute information of each road included in the environment map, the ECU 185 may generate a path that gives priority to a particular type of roads (e.g., roads following along a particular geographic feature such as an agricultural road or a channel; roads that allow satellite signals from the GNSS satellites to be received well; or the like) as a target path.

The ECU 186 generates or edits a map of the environment that is traveled by the work vehicle 100. In the present example embodiment, an environment map that is generated by an external device such as the management device 600 is transmitted to the work vehicle 100, and recorded to the storage 170; however, the ECU 186 may generate or edit the environment map instead. Hereinafter, an operation in the case where the ECU 186 generates the environment map will be described. The environment map may be generated based on the sensor data output from the LiDAR sensor 140. When generating the environment map, the ECU 186 consecutively generates three-dimensional point cloud data based on the sensor data being output from the LiDAR sensor 140 while the work vehicle 100 is traveling. By joining together consecutively generated point cloud data with the use of an algorithm such as SLAM, for example, the ECU 186 can generate an environment map. An environment map thus generated is a highly accurate three-dimensional map, which may be utilized for localization by the ECU 184. Based on this three-dimensional map, a two-dimensional map for use in global path planning can be generated. In the present specification, a three-dimensional map for use in localization and a two-dimensional map for use in global path planning are both referred to as “environment maps”. Furthermore, the ECU 186 can also edit the map by adding various attribute information to the map, such as geographic features (e.g., channels, rivers, grasses, trees, etc.), road types (e.g., whether it is an agricultural road or not), state of the road surface, or accessibility of the road, that is recognized based on data output from the cameras 120 or the LiDAR sensor 140.

Through the actions of these ECUs, the controller 180 realizes self-driving. During self-driving, the controller 180 controls the drive device 240 based on the measured or estimated position of the work vehicle 100 and on the target path. As a result, the controller 180 can cause the work vehicle 100 to travel along the target path.

The plurality of ECUs included in the controller 180 can communicate with one another in accordance with a vehicle bus standard such as, for example, a CAN (Controller Area Network). Instead of a CAN, faster communication methods such as Automotive Ethernet (registered trademark) may be used. Although the ECUs 181 to 186 are illustrated as individual blocks in FIG. 3, the function of each of the ECU 181 to 186 may be implemented by a plurality of ECUs. Alternatively, an onboard computer that integrates the functions of at least some of the ECUs 181 to 186 may be provided. The controller 180 may include ECUs other than the ECUs 181 to 186, and any number of ECUs may be provided in accordance with functionality. Each ECU includes a processing circuit including one or more processors.

The communicator 190 is a device including a circuit communicating with the implement 300, the terminal device 400, and the management device 600. The communicator 190 includes circuitry to perform exchanges of signals complying with an ISOBUS standard such as ISOBUS-TIM, for example, between itself and the communicator 390 of the implement 300. This allows the implement 300 to perform a desired operation, or allows information to be acquired from the implement 300. The communicator 190 may further include an antenna and a communication circuit to exchange signals via the network 80 with the respective communicators of the terminal device 400 and the management device 600. The network 80 may include a 3G, 4G, 5G, or any other cellular mobile communications network and the Internet, for example. The communicator 190 may be configured or programmed to perform communicating with a mobile terminal that is used by a supervisor who is situated near the work vehicle 100. With such a mobile terminal, communication may be performed based on any arbitrary wireless communication standard, e.g., Wi-Fi (registered trademark), 3G, 4G, 5G or any other cellular mobile communication standard, or Bluetooth (registered trademark).

The operational terminal 200 is a terminal for the user to perform an operation related to the travel of the work vehicle 100 and the operation of the implement 300, and is also referred to as a virtual terminal (VT). The operational terminal 200 may include a display device such as a touch screen panel, and/or one or more buttons. The display device may be a display such as a liquid crystal display or an organic light-emitting diode (OLED) display, for example. By manipulating the operational terminal 200, the user can perform various operations, such as, for example, switching ON/OFF the self-driving mode, recording or editing an environment map, setting a target path, and switching ON/OFF the implement 300. At least a portion of these operations may also be realized by manipulating the operation switches 210. The operational terminal 200 may be configured so as to be detachable from the work vehicle 100. A user who is at a remote place from the work vehicle 100 may manipulate the detached operational terminal 200 to control the operation of the work vehicle 100. Instead of the operational terminal 200, the user may manipulate a computer on which necessary application software is installed, for example, the terminal device 400, to control the operation of the work vehicle 100.

FIG. 5 is a diagram showing an example of the operational terminal 200 and an example of the operation switches 210 that are provided inside the cabin 105. Inside the cabin 105, the operation switches 210, including a plurality of switches that are manipulable to the user, are disposed. The operation switches 210 may include, for example, a switch to select the gear shift as to a main gear shift or a range gear shift, a switch to switch between a self-driving mode and a manual driving mode, a switch to switch between forward travel and backward travel, a switch to raise or lower the implement 300, and the like. In the case where the work vehicle 100 only performs unmanned driving and lacks human driving functionality, the work vehicle 100 does not need to include the operation switches 210.

The drive device 340 in the implement 300 shown in FIG. 3 performs operations necessary for the implement 300 to perform predetermined work. The drive device 340 includes a device suitable for uses of the implement 300, for example, a hydraulic device, an electric motor, a pump or the like. The controller 380 controls the operation of the drive device 340. In response to a signal that is transmitted from the work vehicle 100 via the communicator 390, the controller 380 causes the drive device 340 to perform various operations. Moreover, a signal that is in accordance with the state of the implement 300 can be transmitted from the communicator 390 to the work vehicle 100.

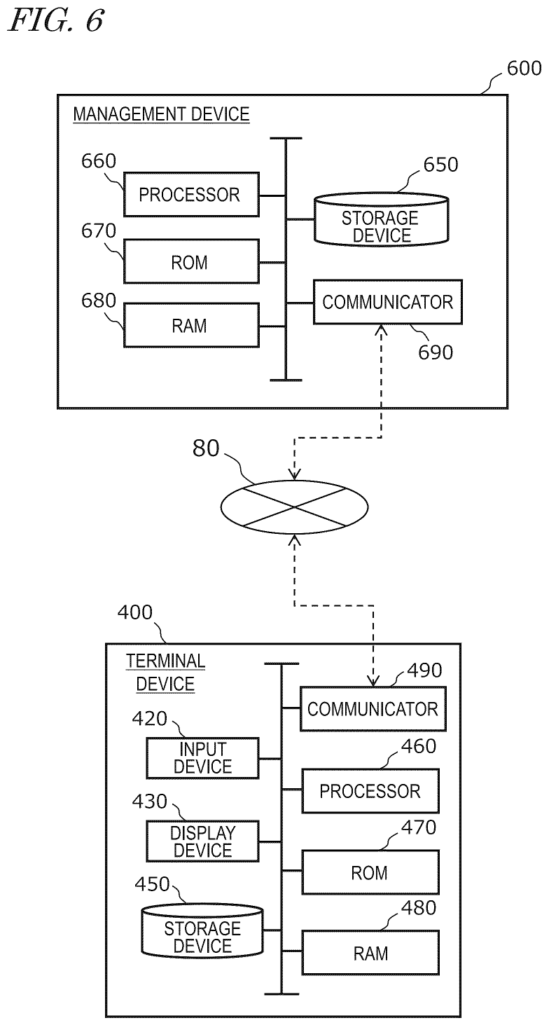

Now, a configuration of the management device 600 and the terminal device 400 will be described with reference to FIG. 6. FIG. 6 is a block diagram showing an example of schematic hardware configuration of the management device 600 and the terminal device 400.

The management device 600 includes a storage 650, a processor 660, a ROM (Read Only Memory) 670, a RAM (Random Access Memory) 680, and a communicator 690. These component elements are communicably connected to one another via a bus. The management device 600 may function as a cloud server to manage the schedule of the agricultural work to be performed by the work vehicle 100 in a field and assist in agriculture by using data that is managed thus. The user can use the terminal device 400 to input information necessary to generate a work plan and upload the information to the management device 600 via the network 80. The management device 600 can generate a schedule of agricultural work, i.e., a work plan, based on the information. The management device 600 can further generate or edit an environment map. The environment map may be distributed from a computer external to the management device 600.

The communicator 690 is a communication module to communicate with the work vehicle 100 and the terminal device 400 via the network 80. The communicator 690 can perform wired communication in compliance with communication standards such as, for example, IEEE1394 (registered trademark) or Ethernet (registered trademark). The communicator 690 may perform wireless communication in compliance with the Bluetooth (registered trademark) or Wi-Fi standards, or cellular mobile communication based on 3G, 4G, 5G or any other cellular mobile communication standard.

The processor 660 may include, for example, a semiconductor integrated circuit including a central processing unit (CPU). The processor 660 may be realized by a microprocessor or a microcontroller. Alternatively, the processor 660 may be realized by an FPGA (Field Programmable Gate Array), a GPU (Graphics Processing Unit), an ASIC (Application Specific Integrated Circuit), or an ASSP (Application Specific Standard Product) having a CPU mounted thereon, or a combination of two or more selected from these circuits. The processor 660 consecutively executes a computer program, describing instructions to execute at least one process, stored in the ROM 670 and thus realizes a desired process.

The ROM 670 is, for example, a writable memory (e.g., PROM), a rewritable memory (e.g., flash memory) or a read-only memory. The ROM 670 stores a program to control operations of the processor 660. The ROM 670 does not need to be a single storage medium, and may be an assembly of a plurality of storage mediums. A part of the assembly of the plurality of storage media may be a removable memory.

The RAM 680 provides a work area in which the control program stored in the ROM 670 is once laid out at the time of boot. The RAM 680 does not need to be a single storage medium, and may be an assembly of a plurality of storage mediums.

The storage 650 mainly functions as a storage for a database. The storage 650 may be, for example, a magnetic storage or a semiconductor storage. An example of the magnetic storage is a hard disk drive (HDD). An example of the semiconductor storage is a solid state drive (SSD). The storage 650 may be a device independent from the management device 600. For example, the storage 650 may be a storage connected to the management device 600 via the network 80, for example, a cloud storage.

The terminal device 400 includes an input device 420, a display device 430, a storage 450, a processor 460, a ROM 470, a RAM 480, and a communicator 490. These component elements are communicably connected to one another via a bus. The input device 420 is a device to convert an instruction from the user into data and input the data to a computer. The input device 420 may be, for example, a keyboard, a mouse or a touchscreen panel. The display device 430 may be, for example, a liquid crystal display or an organic EL display. The description of the processor 460, the ROM 470, the RAM 480, the storage 450, and the communicator 490, which will be the same as set forth with respect to the example hardware configuration of the management device 600, will be omitted.

Next, operations of the work vehicle 100, the terminal device 400, and the management device 600 will be described.

First, an example operation of self-traveling of the work vehicle 100 will be described. The work vehicle 100 according to the present example embodiment can automatically travel both inside and outside a field. Inside the field, the work vehicle 100 drives the implement 300 to perform predetermined agricultural work while traveling along a previously-set target path. Upon detecting an obstacle with the obstacle sensors 130 while traveling inside the field, the work vehicle 100 may halt traveling and perform operations of presenting an alarm sound from the buzzer 220, transmitting an alert signal to the terminal device 400 and the like, for example. Inside the field, the positioning of the work vehicle 100 is performed based mainly on data output from the GNSS unit 110. On the other hand, outside the field, the work vehicle 100 automatically travels along a target path set for an agricultural road or a general road outside the field. While traveling outside the field, the work vehicle 100 utilizes the data acquired by the cameras 120 or the LiDAR sensor 140. When an obstacle is detected outside the field, the work vehicle 100 avoids the obstacle or halts in that place, for example. Outside the field, the position of the work vehicle 100 is estimated based on data output from the LiDAR sensor 140 or the cameras 120 in addition to positioning data output from the GNSS unit 110.

Hereinafter, an example operation of the work vehicle 100 when self-traveling inside the field will be described.

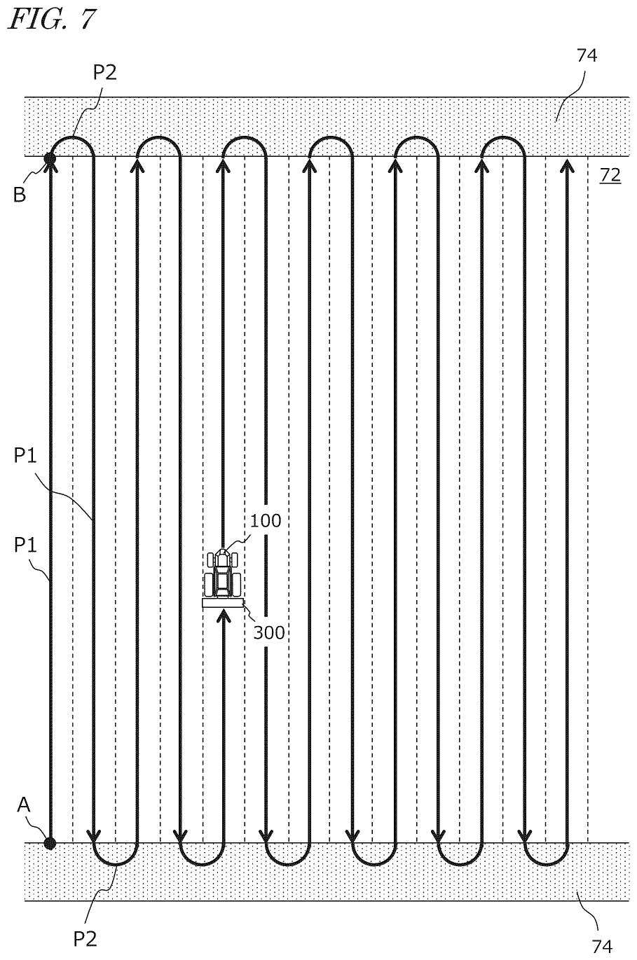

FIG. 7 is a diagram schematically showing an example of the work vehicle 100 automatically traveling along a target path inside a field. In this example, the field includes a work area 72, in which the work vehicle 100 performs work by using the implement 300, and headlands 74, which are located near outer peripheral edges of the field. The user may in advance specify which regions of the field on the map would correspond to the work area 72 and the headlands 74. The target path in this example includes a plurality of main paths P1 parallel to one another and a plurality of turning paths P2 interconnecting the plurality of main paths P1. The main paths P1 are located in the work area 72, whereas the turning paths P2 are located in the headlands 74. Although each main path P1 in FIG. 7 is illustrated as a linear path, each main path P1 may also include a curved portion(s). The main paths P1 may be automatically generated as a user who is looking at a map of the field displayed on the operational terminal 200 or the terminal device 400, by performing an operation of designating two points near the edge of the field (points A and B in FIG. 7), for example. In that case, a plurality of main paths P1 are set so as to be in parallel to a line segment connecting point A and point B designated by the user, and a target path inside the field is generated by connecting these main paths P1 via turning paths P2. Broken lines in FIG. 7 represent a working breadth of the implement 300. The working breadth is previously-set, and recorded in the storage 170. The working breadth may be set and recorded by the user manipulating the operational terminal 200 or the terminal device 400. Alternatively, the working breadth may be automatically recognized and recorded when the implement 300 is connected to the work vehicle 100. The interval between the plurality of main paths P1 may be set in accordance with the working breadth. The target path may be generated based on the user's operation before self-driving is begun. The target path may be generated so as to cover the entirety of the work area 72 inside the field, for example. Along the target path shown in FIG. 7, the work vehicle 100 automatically travels while repeating a reciprocating motion from a start point of work to an end point of work. Note that the target path shown in FIG. 7 is merely an example, and the target path may be determined in any arbitrary manner.

Now, an example control by the controller 180 during self-driving inside the field will be described.

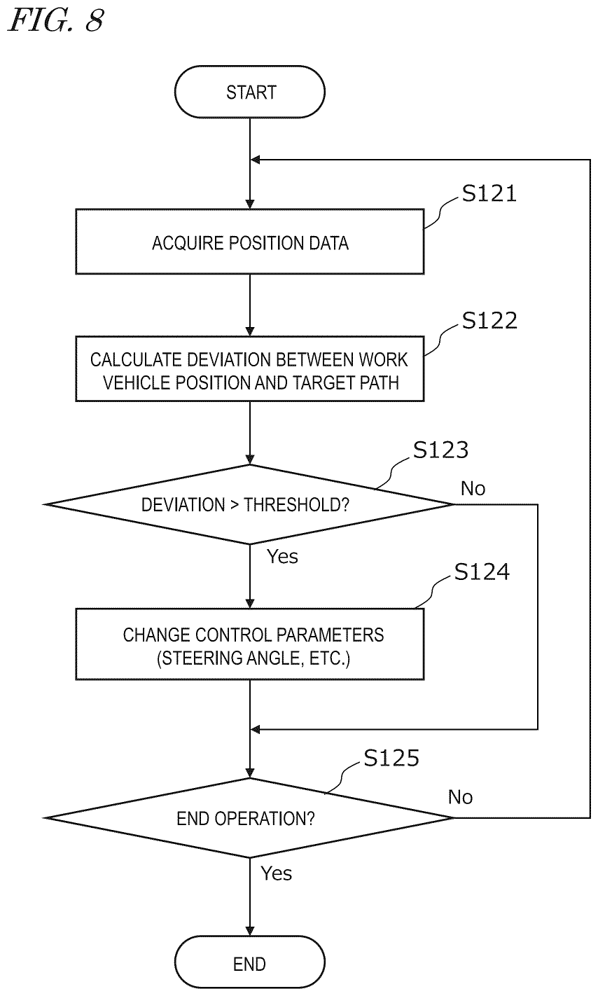

FIG. 8 is a flowchart showing an example operation of steering control to be performed by the controller 180 during self-driving. During travel of the work vehicle 100, the controller 180 performs automatic steering by carrying out the operation from steps S121 to S125 shown in FIG. 8. The speed of the work vehicle 100 will be maintained at a previously-set speed, for example. During travel of the work vehicle 100, the controller 180 acquires data representing the position of the work vehicle 100 that is generated by the GNSS unit 110 (step S121). Next, the controller 180 calculates a deviation between the position of the work vehicle 100 and the target path (step S122). The deviation represents the distance between the position of the work vehicle 100 and the target path at that time. The controller 180 determines whether the calculated deviation in position exceeds a previously-set threshold or not (step S123). If the deviation exceeds the threshold, the controller 180 changes a control parameter of the steering device included in the drive device 240 so as to reduce the deviation, thus changing the steering angle (step S124). If the deviation does not exceed the threshold at step S123, the operation of step S124 is omitted. At the following step S125, the controller 180 determines whether a command to end operation has been received or not. The command to end operation may be given when the user has instructed that self-driving be suspended through remote operations, or when the work vehicle 100 has arrived at the destination, for example. If a command to end operation has not been given, control returns to step S121 and the controller 180 performs a similar operation based on a newly measured position of the work vehicle 100. The controller 180 repeats the operation from steps S121 to S125 until a command to end operation is given. The aforementioned operation is executed by the ECUs 182 and 184 in the controller 180.

In the example shown in FIG. 8, the controller 180 controls the drive device 240 based only on the deviation between the position of the work vehicle 100 as identified by the GNSS unit 110 and the target path. Alternatively, a deviation in terms of directions may further be considered in the control. For example, when a directional deviation exceeds a previously-set threshold, where the directional deviation is an angle difference between the orientation of the work vehicle 100 as identified by the GNSS unit 110 and the direction of the target path, the controller 180 may change the control parameter of the steering device of the drive device 240 (e.g., steering angle) in accordance with the deviation.

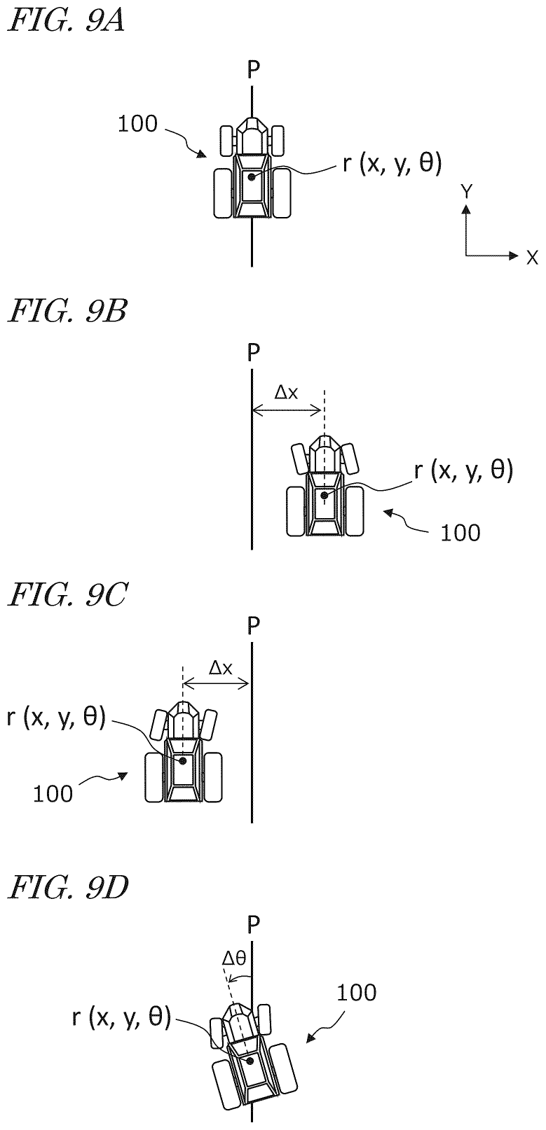

Hereinafter, with reference to FIGS. 9A to 9D, an example of the steering control by the controller 180 will be described more specifically.

FIG. 9A is a diagram showing an example of the work vehicle 100 traveling along a target path P. FIG. 9B is a diagram showing an example of the work vehicle 100 at a position which is shifted rightward from the target path P. FIG. 9C is a diagram showing an example of the work vehicle 100 at a position which is shifted leftward from the target path P. FIG. 9D is a diagram showing an example of the work vehicle 100 oriented in an inclined direction with respect to the target path P. In these figures, the pose, i.e., the position and orientation, of the work vehicle 100 as measured by the GNSS unit 110 is expressed as r(x,y,θ). Herein, (x,y) are coordinates representing the position of a reference point on the work vehicle 100 in an XY coordinate system, which is a two-dimensional coordinate system fixed to the globe. In the examples shown in FIGS. 9A to 9D, the reference point on the work vehicle 100 is at a position, on the cabin, where a GNSS antenna is disposed; however, the reference point may be at any arbitrary position. θ is an angle representing the measured orientation of the work vehicle 100. Although the target path P is shown parallel to the Y axis in the examples illustrated in these figures, the target path P may not necessarily be parallel to the Y axis, in general.

As shown in FIG. 9A, in the case where the position and orientation of the work vehicle 100 are not deviated from the target path P, the controller 180 maintains the steering angle and speed of the work vehicle 100 without changing them.

As shown in FIG. 9B, when the position of the work vehicle 100 is shifted rightward from the target path P, the controller 180 changes the steering angle so that the traveling direction of the work vehicle 100 will be inclined leftward, thus bringing the work vehicle 100 closer to the path P. At this point, not only the steering angle but also the speed may be changed. The magnitude of the steering angle may be adjusted in accordance with the magnitude of a positional deviation Δx, for example.

As shown in FIG. 9C, when the position of the work vehicle 100 is shifted leftward from the target path P, the controller 180 changes the steering angle so that the traveling direction of the work vehicle 100 will be inclined rightward, thus bringing the work vehicle 100 closer to the path P. In this case, too, not only the steering angle but also the speed may be changed. The amount of change of the steering angle may be adjusted in accordance with the magnitude of the positional deviation Δx, for example.

As shown in FIG. 9D, in the case where the position of the work vehicle 100 is not considerably deviated from the target path P but its orientation is nonetheless different from the direction of the target path P, the controller 180 changes the steering angle so that the directional deviation Δθ will become smaller. In this case, too, not only the steering angle but also the speed may be changed. The magnitude of the steering angle may be adjusted in accordance with the magnitudes of the positional deviation Δx and the directional deviation DA, for example. For instance, the amount of change of the steering angle (which is in accordance with the directional deviation DA) may be increased as the absolute value of the positional deviation Δx decreases. When the positional deviation Δx has a large absolute value, the steering angle will be changed greatly in order for the work vehicle 100 to return to the path P, so that the directional deviation Δθ will inevitably have a large absolute value. Conversely, when the positional deviation Δx has a small absolute value, the directional deviation ΔΔ needs to become closer to zero. Therefore, it may be advantageous to introduce a relatively large weight (i.e., control gain) for the directional deviation DA in determining the steering angle.

For the steering control and speed control of the work vehicle 100, control techniques such as PID control or MPC (Model Predictive Control) may be applied. Applying these control techniques will make for smoothness of the control of bringing the work vehicle 100 closer to the target path P.

Note that, when an obstacle is detected by one or more obstacle sensors 130 during travel, the controller 180 halts the work vehicle 100, for example. At this point, the buzzer 220 may be caused to present an alarm sound or an alert signal may be transmitted to the terminal device 400. In the case where the obstacle is avoidable, the controller 180 may generate a local path that allows for avoiding the obstacle and control the drive device 240 such that the work vehicle 100 travels along the path.

The work vehicle 100 according to the present example embodiment can perform self-traveling outside a field as well as inside the field. Outside the field, the controller 180 is able to detect an object located at a relatively distant position from the work vehicle 100 (e.g., another vehicle, a pedestrian, etc.) based on data output from the cameras 120 or the LiDAR sensor 140. The controller 180 generates a local path so as to avoid the detected object, and performs speed control and steering control along the local path, thus achieving self-traveling on a road outside the field.

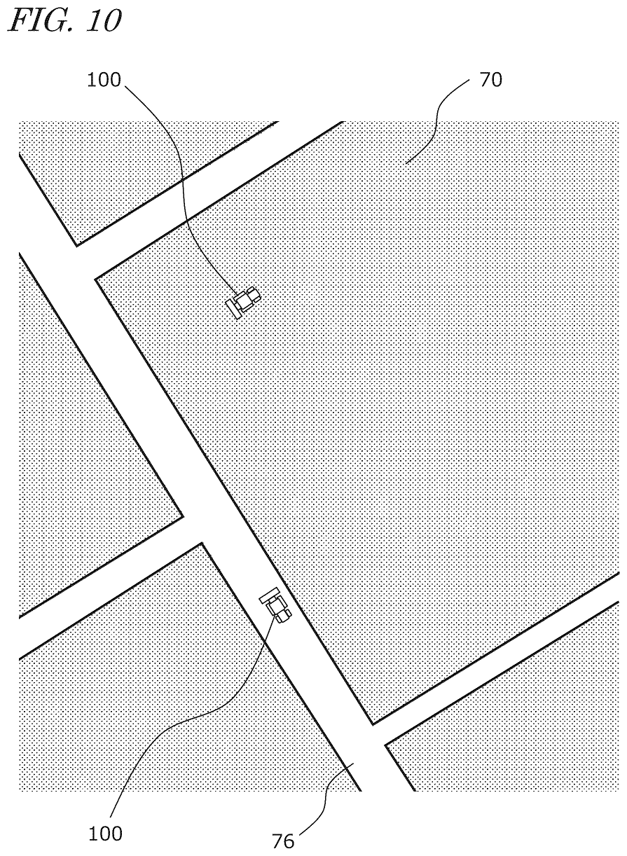

The work vehicle 100 according to the present example embodiment is able to automatically travel inside the field and outside the field in an unmanned manner. FIG. 10 is a diagram schematically showing an example situation where a plurality of work vehicles 100 are self-traveling inside a field 70 and on a road 76 outside the field 70. In the storage 170, an environment map of a region including a plurality of fields and roads around the fields, and a target path, are recorded. The environment map and target paths may be generated by management device 600 or the ECU 185. In the case of traveling on a road, the work vehicle 100 travels along the target path while sensing the surroundings thereof by using the sensing devices such as the cameras 120 and the LiDAR sensor 140, with the implement 300 being raised. During travel, the controller 180 consecutively generates local paths, and causes the work vehicle 100 to travel along the local paths. As a result, it is possible to perform self-traveling while avoiding obstacles. During travel, the target path may be changed depending on the situation.

In accordance with a work plan and a target path generated by the management device 600, the work vehicle 100 according to the present example embodiment automatically performs movement between fields and agricultural work for each field. The work plan includes information on one or more tasks of agricultural work to be performed by the work vehicle 100. For example, the work plan includes information on one or more tasks of agricultural work to be performed by the work vehicle 100 and the field in which each task of agricultural work is to be performed. The work plan may include information on a plurality of tasks of agricultural work for the work vehicle 100 to perform over a plurality of work days, and the field in which each task of agricultural work is to be performed. More specifically, the work plan may be a database including information on a task schedule indicating which agricultural task is to be performed by which agricultural machine at which point of time and in which field for each work day. Hereinafter, an example case will be described where the work plan is the data of such a task schedule. Based on information that is input by the user using the terminal device 400, the work plan may be generated by the processor 660 of the management device 600. Hereinafter, an example method of generating the task schedule will be described.

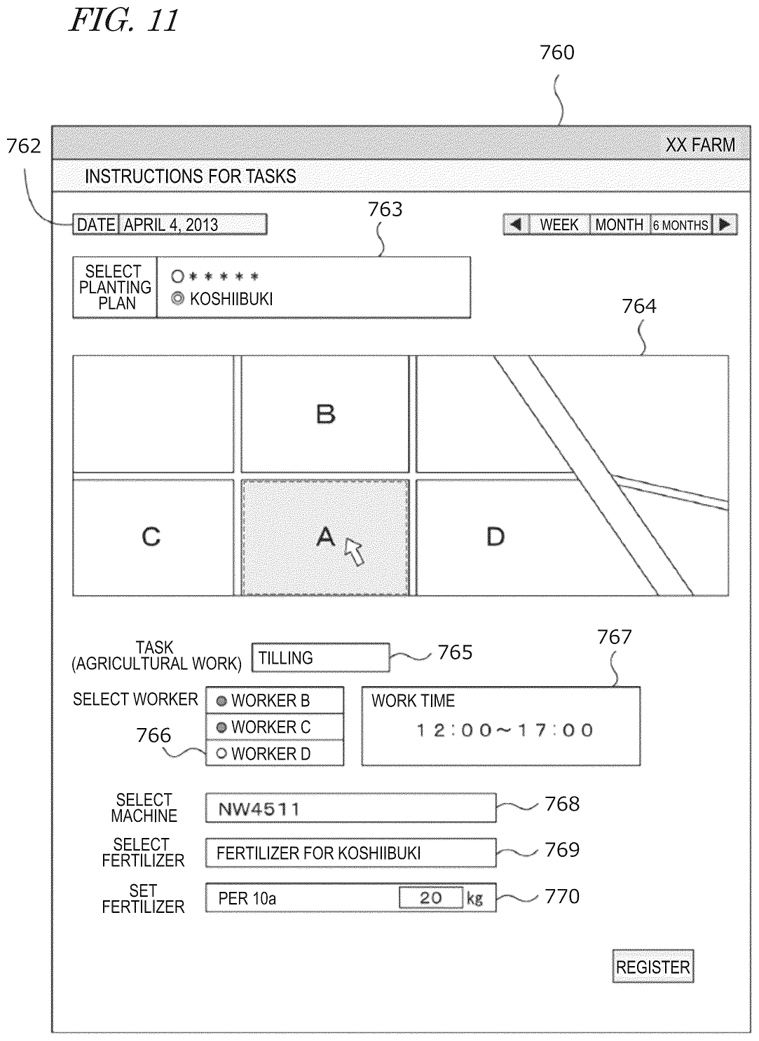

FIG. 11 is a diagram showing an example of a setting screen 760 that is displayed on the display device 430 of the terminal device 400. In accordance with the user's operation by using the input device 420, the processor 460 of the terminal device 400 activates application software for schedule generation to cause the setting screen 760 as shown in FIG. 11 on the display device 430. On this setting screen 760, the user is able to input information that is necessary for generating the task schedule.

FIG. 11 shows an example of the setting screen 760 in a case where tilling, including spreading of a fertilizer, is performed as an agricultural task in a field for rice cultivation. Without being limited to what is illustrated in the figure, the setting screen 760 may be changed as appropriate. The setting screen 760 in the example of FIG. 11 includes a date setting section 762, a planting plan selecting section 763, a field selecting section 764, a task selecting section 765, a worker selecting section 766, a time setting section 767, a machine selecting section 768, a fertilizer selecting section 769, and an application amount setting section 770.

In the date setting section 762, a date that has been input with the input device 420 is displayed. The input date is set as a date for performing the agricultural task.

In the planting plan selecting section 763, a list of names of planting plans that was previously generated is displayed. The user can select a desired planting plan from this list. The planting plan is previously generated for each kind or cultivar of crop, and recorded in the storage 650 of the management device 600. The planting plan is a plan as to which crop is to be planted (i.e., grown) in which field. The planting plan is made by an administrator who manages the plurality of fields, etc., prior to planting a crop in a field. In the example of FIG. 11, a planting plan for “Koshiibuki”, which is a cultivar of rice plant, is selected. In this case, the content to be set on the setting screen 760 is associated with the planting plan for “Koshiibuki”.

In the field selecting section 764, fields in the map are displayed. The user can select any field from among the displayed fields. In the example of FIG. 11, a portion indicating “field A” is selected. In this case, the selected “field A” is set as the field in which an agricultural task is to be performed.

In the task selecting section 765, a plurality of agricultural tasks that are needed in order to cultivate the selected crop are displayed. The user can select one of the plurality of agricultural tasks. In the example of FIG. 11, “tilling” is selected from among the plurality of agricultural tasks. In this case, the selected “tilling” is set as the agricultural task to be performed.

In the worker selecting section 766, previously-registered workers are displayed. The user can select one or more workers from among the plurality of displayed workers. In the example of FIG. 11, from among the plurality of workers, “worker B, worker C” are selected. In this case, the selected “worker B, worker C” are set as the workers to perform or manage the given agricultural task. In the present example embodiment, because the agricultural machine automatically performs the agricultural task, the worker may not actually perform the agricultural task, but only remotely monitor the agricultural task being performed by the agricultural machine.

In the time setting section 767, a task time that is input via the input device 420 is displayed. The task time is designated by a start time and an end time. The input task time is set as a scheduled time at which the agricultural task is to be performed.

The machine selecting section 768 is a portion for setting the agricultural machine to be used for the given agricultural task. In the machine selecting section 768, for example, the types or models of the agricultural machines which have been previously registered by the management device 600, types or models of usable implements, etc., may be displayed. The user can select a specific machine from among the indicated machines. In the example of FIG. 11, an implement model “NW4511” is selected. In this case, this implement is set as the machine to be used for the given agricultural task.

In the fertilizer selecting section 769, names of a plurality of fertilizers which have been previously registered by the management device 600 may be displayed. The user can select a specific fertilizer from among the indicated plurality of fertilizers. The selected fertilizer is set as the fertilizer to be used for the given agricultural task.

In the application amount setting section 770, a numerical value that is input via the input device 420 is displayed. The input numerical value is set as an application amount.

Once a planting plan, a field, an agricultural task, a worker, a task time, a fertilizer, and an application amount are input in the setting screen 760 and “SET” is selected, the communicator 490 of the terminal device 400 transmits the input information to the management device 600. The processor 660 of the management device 600 stores the received information to the storage 650. Based on the received information, the processor 660 generates a schedule of agricultural tasks to be performed by each agricultural machine, and stores it to the storage 650.

Note that the information of agricultural tasks to be managed by the management device 600 is not limited to what is described above. For example, an ability to set the kind and application amount of an agrochemical to be used for the field on the setting screen 760 may be provided. An ability to set information on agricultural tasks other than the agricultural task shown in FIG. 11 may be provided.

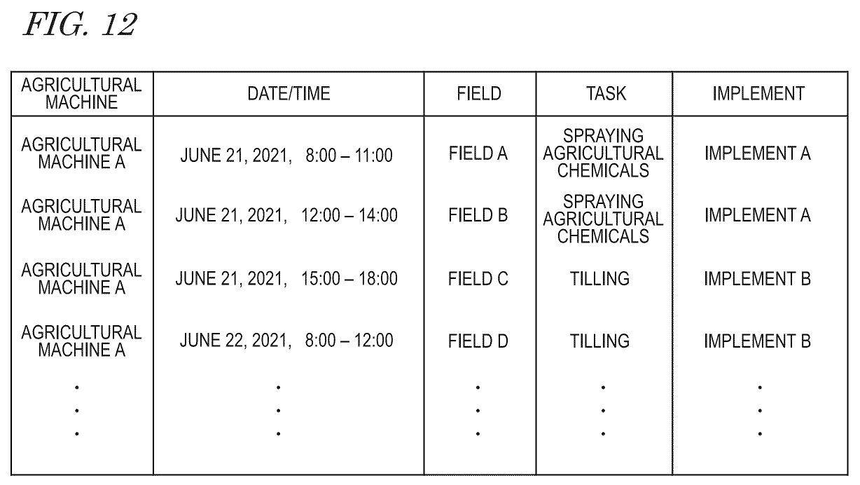

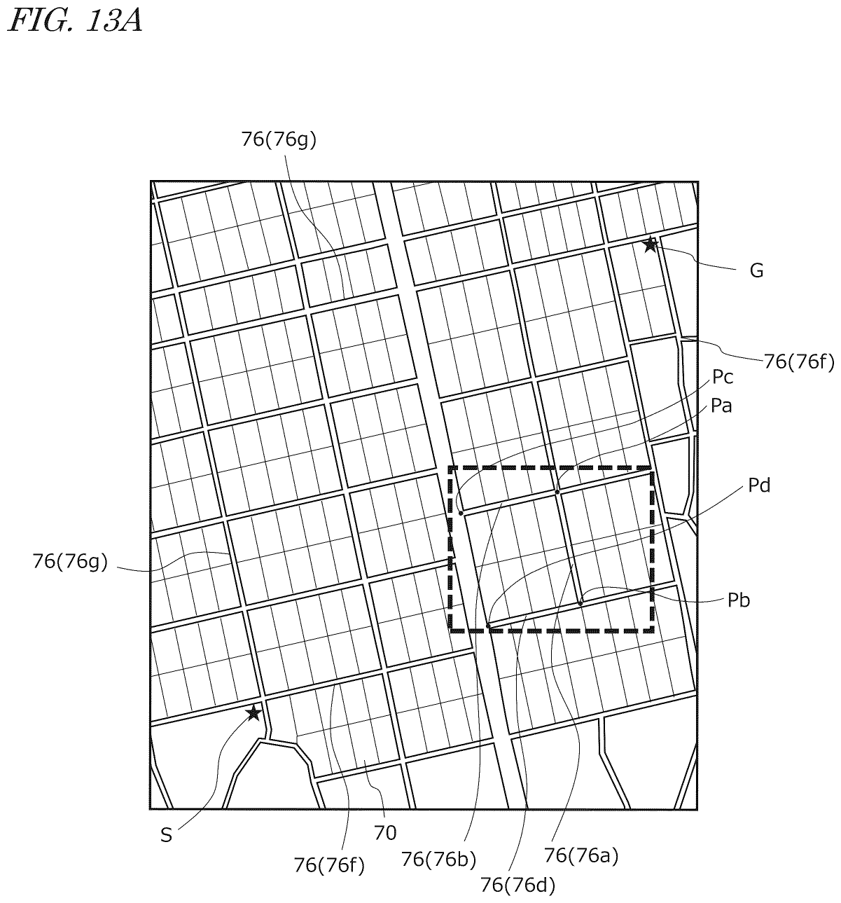

FIG. 12 is a diagram showing an example of a schedule of agricultural tasks (i.e., work plan) to be generated by the management device 600. The schedule in this example includes, for each registered agricultural machine, information indicating the date and time at which the agricultural task is to be performed, the field, the content of work, and the implement used. In addition to the information shown in FIG. 12, depending on the content of work, the schedule may include other information, e.g., information on the kind of agrochemical or the application amount of an agrochemical, for example. In accordance with such a schedule, the processor 660 of the management device 600 instructs the work vehicle 100 as to an agricultural task. The schedule is downloaded by the controller 180 of the work vehicle 100, and may be stored also to the storage 170. In that case, the controller 180 may spontaneously begin operation in accordance with the schedule stored in the storage 170.

Although the work plan is generated by the management device 600 in the present example embodiment, the work plan may be generated by another device. For example, the processor 460 of the terminal device 400 or the controller 180 of the work vehicle 100 may be configured or programmed to generate or update the work plan.

The management device 600 according to the present example embodiment may be configured or programmed to function as a map data generation system to generate map data for an agricultural machine (which in this example is the work vehicle 100) to perform self-driving. “Map data for an agricultural machine to perform self-driving” is data in which the positions or regions of things (including geographic features) existing in an environment where the agricultural machine performs self-driving are expressed by a predetermined coordinate system, and may further include attribute information of those things. To “generate map data for an agricultural machine to perform self-driving” encompasses adding any new data to the map data, and also updating (or modifying) any data included in the map data.

The management device 600, functioning as a map data generation system according to the present example embodiment, includes a storage 650 to store map data for an agricultural machine that performs self-driving, and a processor 660. When data of a road is not included in a predetermined region indicated by the map data, the processor 660 generates data of the road in the predetermined region based on a trajectory of a vehicle including a GNSS receiver and traveling in the predetermined region, the trajectory being acquired in the predetermined region based on GNSS data that is output from the GNSS receiver, and attribute information of the vehicle. To “generate data of a road in a predetermined region” encompasses newly adding the road as a geographic feature existing in the predetermined region indicated in the map data. Note that to “generate data of a road in a predetermined region” may encompass, when data of the road is already included in the predetermined region indicated in the map data, adding or updating (modifying) the data of the attribute information of the road. The “predetermined region” is a previously-set region in the map data, and is recorded in the storage 650 of the management device 600, for example.

The management device 600 according to the present example embodiment may further cooperate with the control system 160 of the work vehicle 100 to function as a path planning system for the work vehicle 100. The path planning system according to the present example embodiment includes the aforementioned map data generation system. In the path planning system, the processor 660 of the management device 600 generates a path for the work vehicle 100 that performs self-driving to travel outside fields by using data of the road in the predetermined region in the map data. In other words, the processor 660 of the management device 600 in the path planning system can generate a path (global path) for the work vehicle 100 that performs self-driving by using data of a road that is generated by the processor 660 of the management device 600 in the map data generation system.

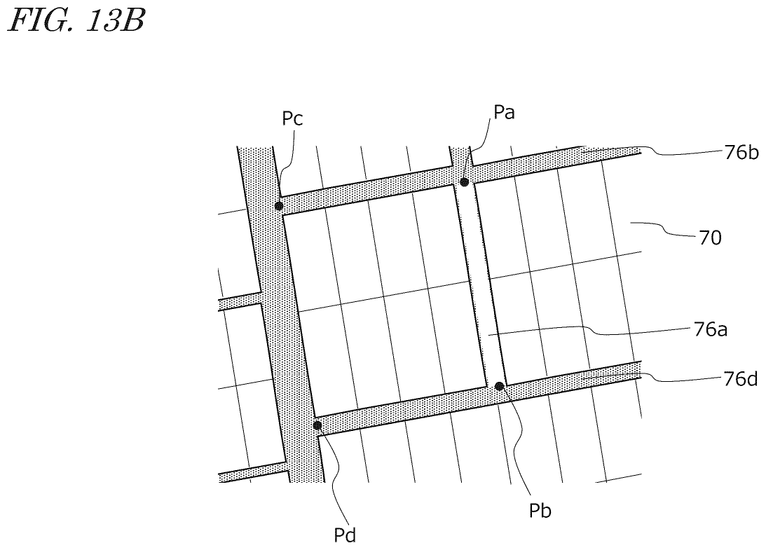

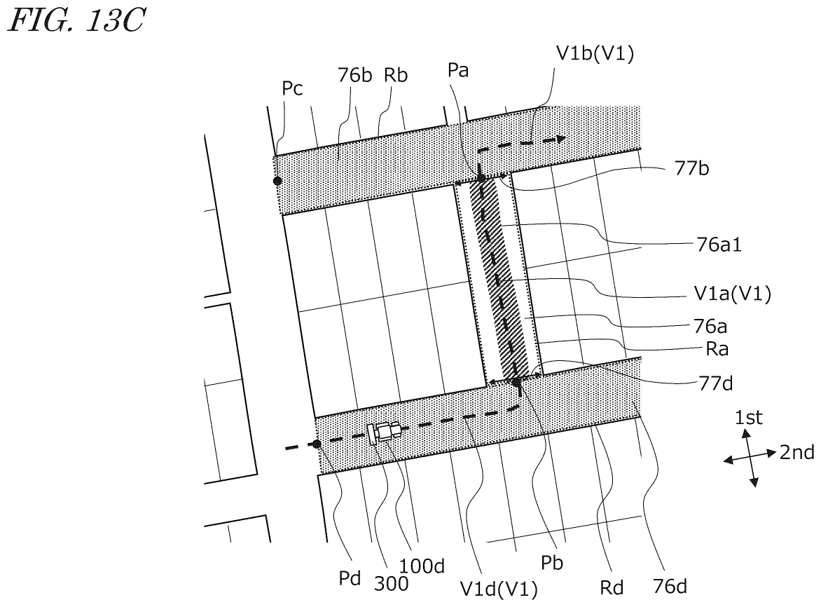

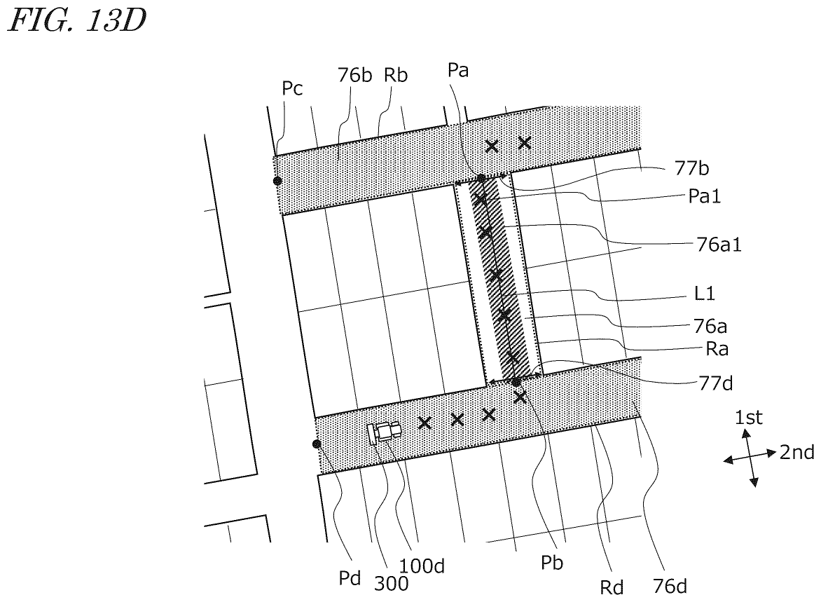

With reference to FIG. 13A, FIG. 13B, FIG. 13C, and FIG. 13D, the map data generation system and path planning system according to the present example embodiment will be described. FIG. 13A is a diagram schematically showing a region (surrounding environment) in which the work vehicle 100, which is an agricultural machine, performs self-driving. FIG. 13B is a diagram schematically showing a map of a region (surrounding environment) in FIG. 13A that is surrounded by broken lines. FIG. 13C and FIG. 13D are schematic diagrams for describing a procedure by which the map data generation system according to the present example embodiment generates map data by using the map data of FIG. 13B.

The map data of FIG. 13B is stored in the storage 650 of the management device 600, for example. The map data of FIG. 13B is a two-dimensional digital map, and may be generated by the management device 600 or another device. The map data of FIG. 13B may have been generated based on data that was externally acquired by the management device 600. Although the map shown in FIG. 13B is a two-dimensional digital map, the map data generation system and path planning system according to the present example embodiment are also applicable to map data of other formats, e.g., a point cloud map or a grid map, and are applicable not only to two-dimensional map data but also to three-dimensional map data. Map data as shown in FIG. 13B is generated across the entirety of the region that may be traveled by the work vehicle 100.

The region shown in FIG. 13A includes a plurality of fields 70 where the work vehicle 100 performs agricultural work and roads 76 around the fields (including agricultural roads 76g and general roads 76f). In FIG. 13A, examples of a departure point S and a destination point G of self-traveling by the work vehicle 100 are indicated by ★ symbols. The departure point S and the destination point G may be set by the user, for example. Alternatively, the management device 600 may set the departure point S and the destination point G in accordance with the task schedule on the work day. As has been described with reference to FIG. 12, the task schedule for each work day is previously generated by the management device 600 and stored in the storage 650. In addition to the departure point S and the destination point G, one or more waypoints may be set. For each of the departure point S, the destination point G, and the waypoint(s), one or both of a scheduled time of arrival and a scheduled time of departure may be recorded.

Regarding these geographic features, the map data of FIG. 13B, which corresponds to the region in FIG. 13A that is surrounded by broken lines, includes information (data) on their positions (e.g., latitudes and longitudes). The map data of FIG. 13B may further include attribute information of the geographic features. For example, the map data of FIG. 13B may include, for each road 76, information indicating a category of the road (e.g., whether it is an agricultural road or not) and information concerning width. Herein, it is assumed that a road 76a, a road 76b, and a road 76d, which exist in the region in FIG. 13A that is surrounded by broken lines, are all agricultural roads. However, it is assumed that the map data of FIG. 13B does not include data of the road 76a between point Pa and point Pb, among the geographic features existing in the region in FIG. 13A that is surrounded by broken lines. In other words, the road 76a does not exist on the map data of FIG. 13B. In FIG. 13B, any region where some data of a road exists is shown hatched. In a state where the map data of FIG. 13B is stored in the storage 650, the processor 660 of the management device 600 cannot recognize any path that includes the road 76a as a path for the work vehicle 100.

With reference to FIG. 13C, a procedure by which the map data generation system according to the present example embodiment generates map data by using the map data of FIG. 13B will be described. In this example, the map data generation system according to the present example embodiment generates data of the road 76a in the map data of FIG. 13B. In other words, in this example, a region Ra corresponding to the road 76a is previously-set as the predetermined region, and is stored in the storage 650 of the management device 600, for example. FIG. 13C and FIG. 13D each show the region Ra corresponding to the road 76a, a region Rb corresponding to the road 76b, and a region Rd corresponding to the road 76d. The predetermined region does not need to be commensurate with the region in which the road 76a exists. For example, the predetermined region for generating data of the road 76a extending along the top-bottom direction (first direction) in the figures may be a region that is defined by: a line segment 77b that is a portion of a downward edge (lower edge) of the road 76b, which is located above the road 76a; and a line segment 77d that is a portion of an upward edge (upper edge) of the road 76d, which is located below the road 76a. In the figures, the line segment 77b being a portion of the lower edge of the road 76b and the line segment 77d being a portion of the upper edge of the road 76d are indicated by double-headed arrows. The line segment 77b and the line segment 77d are line segments extending along a second direction that intersects the first direction. The second direction may be orthogonal to the first direction, but is not limited to being orthogonal to the first direction. Point Pa is located on the line segment 77b, which is included in the lower edge of the road 76b, whereas point Pb is located on the line segment 77d, which is included in the upper edge of the road 76d.

The region in which the processor 660 is to acquire the trajectory of the vehicle (predetermined region) may be a substantially rectangular region that is defined by two line segments as in the aforementioned example, but the method of designating the predetermined region is not limited to this example. The user may be given an ability to set/change the predetermined region. The predetermined region in the illustrated example is such that the region corresponding to the road 76a extends along the first direction; however, a region corresponding to a road that extends in a curve form may be designated as the predetermined region. Not only one but a plurality of predetermined regions may be set, and the following process may be performed for each of the plurality of predetermined regions on the map data.

As shown in FIG. 13C, in the map data generation system according to the present example embodiment, when data of a road is not included in a predetermined region (which herein is the region Ra corresponding to the road 76a) in the map data, the processor 660 of the management device 600 generates data of the road 76a in the map data of FIG. 13B based on a trajectory V1a in the region Ra of a vehicle 100d including a GNSS receiver and traveling in the region Ra, the trajectory being acquired based on GNSS data that is output from the GNSS receiver, and attribute information of the vehicle 100d. In this context, attribute information of the vehicle that has actually traveled the road 76a may be stored to the storage 650 in association with the data of the road 76a in the map data. Through communication with the vehicle 100d, the processor 660 acquires the attribute information of the vehicle 100d.

Note that, as for the vehicle including a GNSS receiver and traveling in the predetermined region, a trajectory and attribute information of not only an agricultural machine but also any automobile other than an agricultural machine (e.g., a car, a kei truck, or a truck) or any work vehicle intended for tasks other than agricultural work may be used. The trajectory of the vehicle including a GNSS receiver may be a trajectory that is acquired as a continuous line based on GNSS data as in the example shown in FIG. 13C, or a trajectory that is obtained by connecting together a plurality of discrete points that are acquired based on GNSS data, as will be described below with reference to FIG. 13D.

The example shown in FIG. 13C will be described more specifically. In the example shown in FIG. 13C, the vehicle 100d turns left in the middle of the road 76d to go into the road 76a, travels along the road 76a from point Pb to point Pa, goes from point Pa into the road 76b, and travels along the road 76b. In this while, the processor 660 can obtain a trajectory V1 of the vehicle 100d. In this example, the region Rd corresponding to the road 76d, the region Ra corresponding to the road 76a, and the region Rb corresponding to the road 76b do not overlap one another, and they abut one another at their border lines. The acquired trajectory V1 of the vehicle 100d includes a trajectory V1d of traveling in the region Rd corresponding to the road 76d, a trajectory V1a of traveling in the region Ra corresponding to the road 76a, and a trajectory V1b of traveling in the region Rb corresponding to the road 76b. Within the acquired trajectory V1, the processor 660 uses the trajectory V1a of the vehicle 100d in the region Ra corresponding to the road 76a to generate data of the road 76a. Within the trajectory V1 of the vehicle 100d, the processor 660 does not use the trajectory V1b in the region corresponding to the road 76b and the trajectory V1d in the region corresponding to the road 76d, but only uses the trajectory V1a in the region Ra corresponding to the road 76a. If data of a road does not exist in the predetermined region that is previously set (which herein is the region Ra) and if the trajectory V1 of the vehicle 100d exists in that predetermined region, then, out of the trajectory V1, the processor 660 uses the trajectory V1a in the region Ra to generate data of the road 76a. For example, the processor 660 may obtain the trajectory V1a by extracting, out of the trajectory V1, a portion which does not overlap the region Rd corresponding to the road 76d and which also does not overlap the region Rb corresponding to the road 76b.

Moreover, the processor 660 acquires attribute information of the vehicle 100d. The attribute information of the vehicle acquired by the processor 660 of the management device 600 is information concerning an attribute of the vehicle, e.g., information on the width of the vehicle, information on the type of the vehicle, information as to whether the vehicle is an agricultural machine or not, information as to whether the vehicle has an implement attached thereto or not, and information as to whether the vehicle is an agricultural machine having an implement attached thereto or not. In a case where the vehicle has an implement attached thereto, information on the width of the attached implement, information on the type of the implement, and the like may further be included. For example, the processor 660 of the management device 600 may acquire information on the width of the vehicle as the attribute information of the vehicle, and set the width of the road 76a in the map data to be equal to or greater than the acquired value of vehicle width. For example, the acquired value of vehicle width may be stored to the storage 650 as a lower limit value of the width of the road 76a.

For example, as attribute information of the vehicle 100d, the processor 660 acquires the width of the vehicle or the width of the implement attached to the vehicle. For example, as attribute information of the vehicle, the processor 660 may acquire information on the width of the vehicle, information as to whether the vehicle has an implement attached thereto or not, and if the vehicle has an implement attached thereto, information on the width of the implement. For example, the processor 660 of the management device 600 may, if the vehicle (agricultural machine) has an implement attached thereof, set the width of the road 76a in the map data to equal to or greater than the acquired value of the implement width, and if the vehicle does not have an implement attached thereto, the processor 660 of the management device 600 may set the width of the road 76a in the map data to equal to or greater than the acquired value of vehicle width. When the vehicle has an implement attached thereto, the processor 660 may set whichever one is the greater between the width of the vehicle body and the width of the implement as a lower limit value of the width of the road 76a in the map data. In the illustrated example, the vehicle 100d is an agricultural machine (tractor) having the implement 300 attached thereto. As shown in FIG. 13C, the processor 660 generates diagram data 76a1 in which the width of the trajectory V1a (line) of the vehicle 100d is set to the width of the vehicle body 100d or to the width of the implement 300, and sets the generated diagram data 76a1 as data of the road 76a. The region of the diagram data 76a1 may be regarded as the region indicative of the road 76a. The processor 660 connects (associates) both ends of the road 76a (diagram data 76a1) to the roads 76d and 76b.

As shown in FIG. 13D, the processor 660 may refer (acquire) to a plurality of points Pa1 (indicated by x symbols in the figure) included in the trajectory V1a of the vehicle 100d, derive a line L1 that approximates the trajectory V1a of the vehicle by least-squares method or the like, generate diagram data 76a1 in which the width of the line L1 is set to the width of the vehicle body 100d or to the width of the implement 300, and set the generated diagram data 76a1 as map data of the road 76a. In this case, too, the processor 660 connects both ends of the road 76a (diagram data 76a1) to the roads 76d and 76b.

By using the map data generation system according to the present example embodiment, map data for an agricultural machine that performs self-driving can be generated efficiently. For example, an agricultural road may possibly be not as well-maintained as a general road, and such an inadequately maintained road may not exist in the map data. By using the map data generation system according to the present example embodiment, it becomes possible to add data of the road to the map data, based on information on a vehicle including a GNSS receiver and having actually traveled along that road (which herein is information including the trajectory of the vehicle and attribute information of the vehicle). By using not only the trajectory of the vehicle but also attribute information of that vehicle, it becomes possible to add the attribute information of the road to the map data based on an actual record of the vehicle that has actually traveled along that road. Because the attribute information of the vehicle that has actually traveled along that road is stored to the storage 650 in association with the data of the road 76a, map data that is useful for an agricultural machine that performs self-driving can be generated.

By using the path planning system according to the present example embodiment, it is possible to generate a suitable path for an agricultural machine that performs self-driving (work vehicle 100). For example, a road such as an agricultural road that is inadequately maintained can be included in the path (global path) for the agricultural machine that performs self-driving. By using map data that is obtained through the procedure described with reference to FIG. 13C or FIG. 13D, for example, the path planning system according to the present example embodiment can generate a path including the road 76a as the path for the work vehicle 100. Because the road 76a can be included in the path, a more suitable path for the agricultural machine that performs self-driving (e.g., a path that allows to arrive at the destination in a shorter distance and/or time) may be generated. In the case where information on the width of each road is included in the map data, the path planning system according to the present example embodiment can combine roads having a width that is equal to or less than the width of the work vehicle 100 to generate a path for the work vehicle 100. In the case where the work vehicle 100 has an implement attached thereto, a path may be generated by combining roads having a width that is equal to or less than the width of the implement. Information on the type or width of the implement attached to the work vehicle 100 is recorded in the storage 170 of the work vehicle 100, for example. The implement may be automatically recognized when it becomes connected to the work vehicle 100, and recorded.

In the case where the attribute information of the vehicle acquired by the processor 660 of the management device 600 includes information as to whether the vehicle is an agricultural machine or not, the processor 660 of the management device 600 may set the category of the road 76a in the map data to agricultural road if the vehicle is an agricultural machine. For example, information on the category (e.g., distinction as to agricultural road/general road) of the road 76a may be stored to the storage 650 in association with the data of the road 76a.

In the case where the attribute information of the vehicle acquired by the processor 660 of the management device 600 includes information on the width of the vehicle and information as to whether the vehicle is an agricultural machine having an implement attached thereto or not, the processor 660 of the management device 600 may set the width of the road 76a in the map data to equal to or greater than the width of the implement if the vehicle is an agricultural machine having an implement attached thereto. For example, the acquired value of the implement width may be stored to the storage 650 as a lower limit value of the width of the road 76a.

Based on the trajectory of the vehicle traveling in the region Ra corresponding to the road 76a, the processor 660 of the management device 600 may acquire the orientation(s) of the vehicle at one or more points existing in the region Ra, and set the acquired orientation(s) of the vehicle as the orientation(s) of the respective point(s) on the road 76a. The processor 660 of the management device 600 may cause the orientation(s) of the vehicle at one or more points in the region Ra corresponding to the road 76a to be stored to the storage 650 as the orientation(s) of the road 76a at the respective point(s). The processor 660 of the management device 600 may generate data of the road 76a by using the orientations at a plurality of points (positions) in the region Ra corresponding to the road 76a.

The processor 660 of the management device 600 may hold the generated data of the road 76a and other roads existing in the map data of FIG. 13B in association. For example, the processor 660 of the management device 600 may link (associate) the generated data of the road 76a with data of the road 76b and road 76d existing in the map data of FIG. 13B. By using map data in which data of the road 76a and data of the road 76b and road 76d are associated, the path planning system according to the present example embodiment can generate a suitable path for an agricultural machine that performs self-driving.

With respect to any region of the map data in which data of a road is already included, too, based on information on a vehicle including a GNSS receiver and actually traveling the road (which herein is information including the trajectory of the vehicle and attribute information of the vehicle), the processor 660 of the management device 600 can update data of attribute information of the road in the map data. For example, if map data obtained through the procedure described with reference to FIG. 13C is stored in the storage 650, then data of the road 76a is included in the map data. In this case, the processor 660 of the management device 600 can update data of attribute information of the road 76a in the map data based on a trajectory through the region Ra of a vehicle including a GNSS receiver and traveling in the region Ra corresponding to the road 76a, the trajectory being acquired based on GNSS data that is output from the GNSS receiver, and attribute information of that vehicle. Updating the data of a road in the map data allows for maintaining the accuracy of the map data.

For example, in the case where the attribute information of the vehicle acquired by the processor 660 of the management device 600 includes information on the width of the vehicle, the processor 660 of the management device 600 determines whether the acquired vehicle width is greater than the width of the road 76a as stored in the storage 650 or not, and, if the acquired vehicle width is greater than the width of the road 76a stored in the storage 650, rewrites (updates) the width of the road 76a stored in the storage 650 to the acquired vehicle width. If the acquired vehicle width is equal to or less than the width of the road 76a as stored in the storage 650, the processor 660 of the management device 600 does not update the width of the road 76a stored in the storage 650.

In the case where the attribute information of the vehicle acquired by the processor 660 of the management device 600 includes information on the width of the vehicle and information as to whether the vehicle is an agricultural machine having an implement attached thereto or not, the processor 660 of the management device 600 may acquire the width of the implement if the vehicle is an agricultural machine having an implement attached thereto, and determine whether the width of the implement is greater than the width of the road 76a as stored in the storage 650 or not. If width of the implement is greater than the width of the road 76a as stored in the storage 650, the processor 660 of the management device 600 rewrites (updates) the width of the road 76a stored in the storage 650 to the width of the implement. If the width of the implement is equal to or less than the width of the road 76a as stored in the storage 650, the processor 660 of the management device 600 does not update the width of the road 76a stored in the storage 650.

As in the described example, the processor 660 of the management device 600 may update data of a road that it has generated (which herein is data of the road 76a), or update data of any other road.

When a trajectory of the vehicle including a GNSS receiver and traveling in the predetermined region is acquired based on GNSS data that is output from the GNSS receiver, the processor 660 of the management device 600 may further acquire reception intensities of satellite signals by the GNSS receiver included in the vehicle. Based on the reception intensities of satellite signals by the GNSS receiver, the processor 660 of the management device 600 may determine whether acquisition of the trajectory of the vehicle was made in a situation where satellite signals can be properly received or not. When the reception intensities of satellite signals by the GNSS receiver are higher than a predetermined intensity, for example, the processor 660 of the management device 600 may determine that acquisition of the trajectory of the vehicle was made in a situation where satellite signals can be properly received. The processor 660 of the management device 600 may perform the generation or update of data of a road only when determining that acquisition of the trajectory of the vehicle was made in a situation where satellite signals can be properly received.

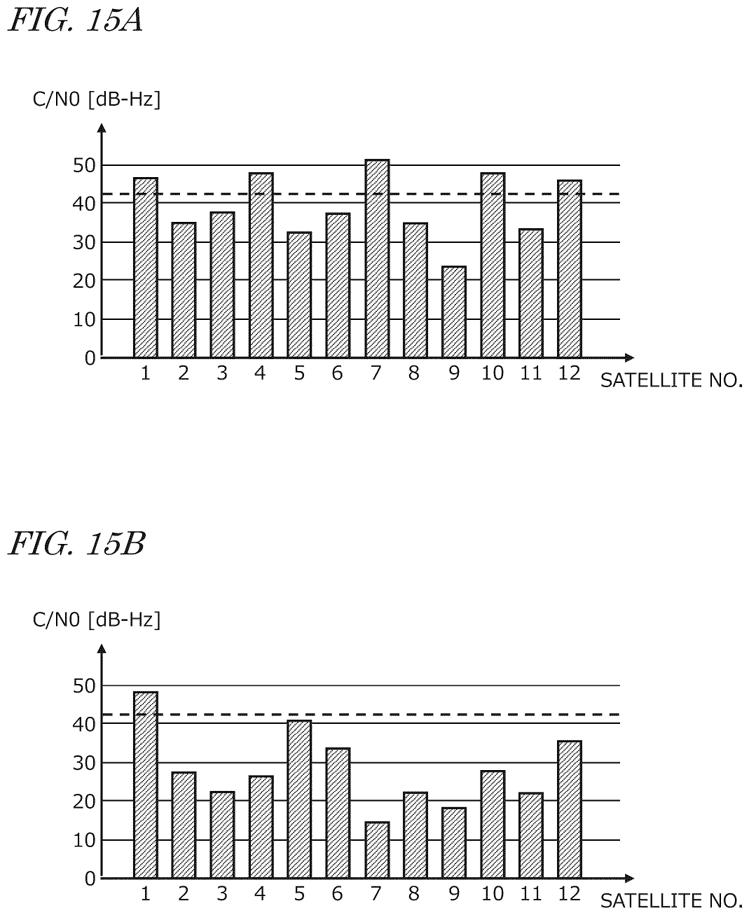

FIG. 15A and FIG. 15B are diagrams showing examples of reception intensities of satellite signals. FIG. 15A shows, in a situation where satellite signals can be properly received, an example of reception intensities of the satellite signals. FIG. 15B shows, in a situation where satellite signals cannot be properly received (i.e., reception problems may be present), an example of reception intensities of the satellite signals. In these examples, satellite signals are received from twelve satellites, and their reception intensities are expressed by values of carrier to noise density ratio (C/NO). Note that this is only an example, and the number of satellites from which satellite signals are receivable and the expression of reception intensities may depend on the system. As one example, the presence or absence of reception problems can be determined based on whether the number of satellites for which the reception intensity exceeds a previously-set reference value is equal to or greater than a threshold (e.g., 4). In FIG. 15A and FIG. 15B, an example of a reference value for reception intensities is shown by a broken line. When the threshold is, e.g., 4, in the example of FIG. 15A, the number of satellites for which the reception intensity exceeds the reference value is five, which is equal to or greater than the threshold. Therefore, such a case is determined as a situation where satellite signals can be properly received. On the other hand, in the example of FIG. 15B, the number of satellites for which the reception intensity exceeds the reference value is one, which is smaller than the threshold. Therefore, such a case is determined not to be a situation where they can be properly received. Note that the aforementioned method is only an example, and other methods may be used in determining whether each road is a road for which satellite signals can be properly received or not. For example, in a case where the GNSS data includes a value indicating the reliability of positioning, this reliability value may be used in determining whether satellite signals can be properly received or not.

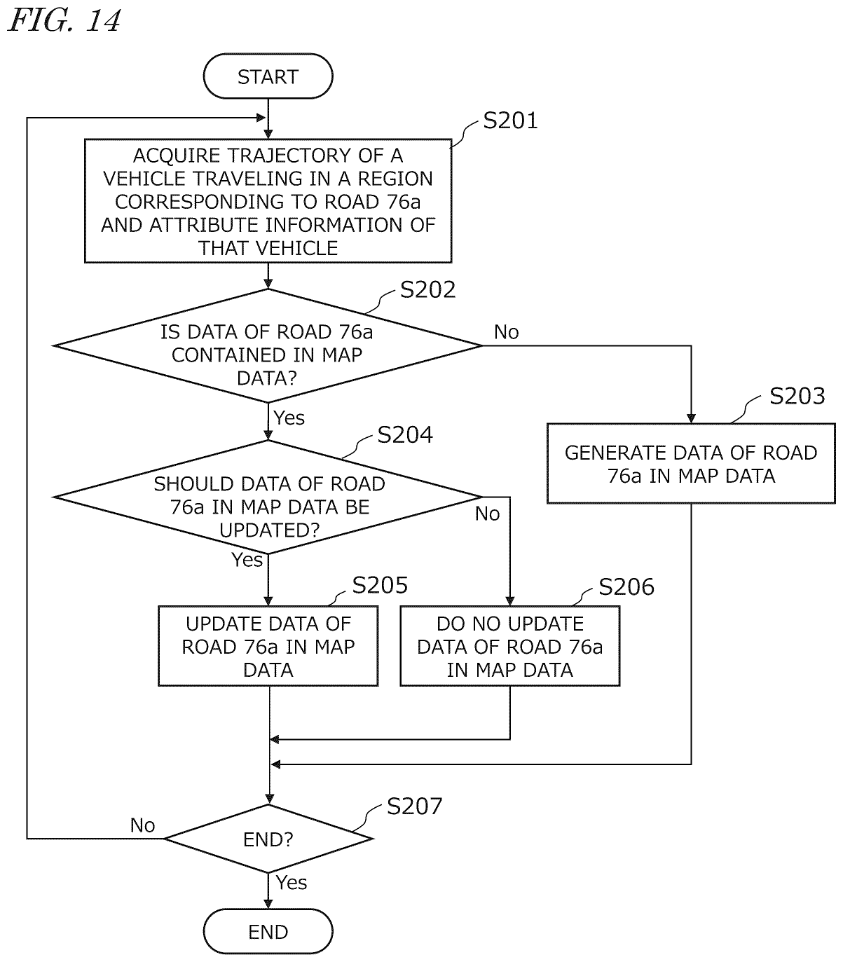

FIG. 14 is a flowchart showing an example of map generation process by the processor 660 of the management device 600 that has been described with reference to FIG. 13A to FIG. 13D.

At step S201, based on GNSS data that is output from a GNSS receiver of a vehicle including the GNSS receiver and traveling in the region Ra corresponding to the road 76a, the processor 660 of the management device 600 acquires a trajectory of the vehicle traveling in the region Ra corresponding to the road 76a and attribute information of that vehicle.

At step S202, the processor 660 of the management device 600 determines whether data of the road 76a is included in map data that is stored in the storage 650 or not. Note that step S202 may be performed before step S201.

As in the map data of FIG. 13B, for example, if data of the road 76a is not included in the map data stored in the storage 650, the processor 660 of the management device 600 generates data of the road 76a in the map data stored in the storage 650, based on the trajectory of the vehicle traveling in the region Ra corresponding to the road 76a and the attribute information of that vehicle as acquired at step S201 (step S203).

As in the map data obtained through the procedure described with reference to FIG. 13C, for example, if data of the road 76a is already included in the map data stored in the storage 650, the processor 660 of the management device 600 determines whether the data of the road 76a in the map data stored in the storage 650 should be updated or not, based on the trajectory of the vehicle traveling in the region Ra corresponding to the road 76a and the attribute information of that vehicle as acquired at step S201 (step S204).

If it is determined at step S204 that an update should be made, the processor 660 of the management device 600 updates the data of the attribute information of the road 76a in the map data stored in the storage 650 (step S205). If it is determined at step S204 that an update is not necessary, the processor 660 of the management device 600 does not update the data of the road 76a in the map data stored in the storage 650 (step S206).

Until a command to end is given (step S207), the processor 660 of the management device 600 repeats the operation from step S201 to step S206.

An example has been described above where the processor 660 of the management device 600 functions as the processor of the map data generation system; however, in the map data generation system, a part or a whole of the processing that is performed by the processor 660 of the management device 600 may be performed by another device. Such another device may be any of the terminal device 400 (processor 460), the controller 180 of the work vehicle 100 (ECU 186 for map generation), or the operational terminal 200. For example, in a case where a portion of the processing performed by the processor 660 of the management device 600 is performed by the controller 180, a combination of the management device 600 and the controller 180 functions as the processor of the map data generation system. In the case where the combination of the management device 600 and the controller 180 functions as the processor of the map data generation system, map data may be stored to the storage 170 of the work vehicle 100.

When the work vehicle 100 is traveling outside the field, obstacles such as pedestrians or other vehicles may exist on or near a global path. In order to prevent the work vehicle 100 from colliding the obstacles, the ECU 185 in the controller 180 consecutively generates local paths that allow for avoiding obstacles during travel of the work vehicle 100. While the work vehicle 100 is traveling, the ECU 185 generates local paths based on sensor data that is acquired by the sensing devices (the obstacle sensors 130, the LiDAR sensor 140, the cameras 120, etc.) included in the work vehicle 100. A local path is defined by a plurality of waypoints following along part of a second path 30B. Based on the sensor data, the ECU 185 determines whether any obstacle exists on or near the path ahead of the work vehicle 100. If any such obstacle exists, the ECU 185 generates a local path by setting a plurality of waypoints so as to avoid the obstacle. If no obstacle exists, the ECU 185 generates a local path essentially in parallel to the second path 30B. Information representing the generated local path is sent to the ECU 184 for self-driving control. The ECU 184 controls the ECU 181 and the ECU 182 so that the work vehicle 100 will travel along the local path. As a result, the work vehicle 100 is able to travel while avoiding the obstacle. In a case where a traffic light exists on the road traveled by the work vehicle 100, the work vehicle 100 may perform an operation of recognizing the traffic light based on images captured by the cameras 120, stopping at a red light, and pulling out on a green light, for example.

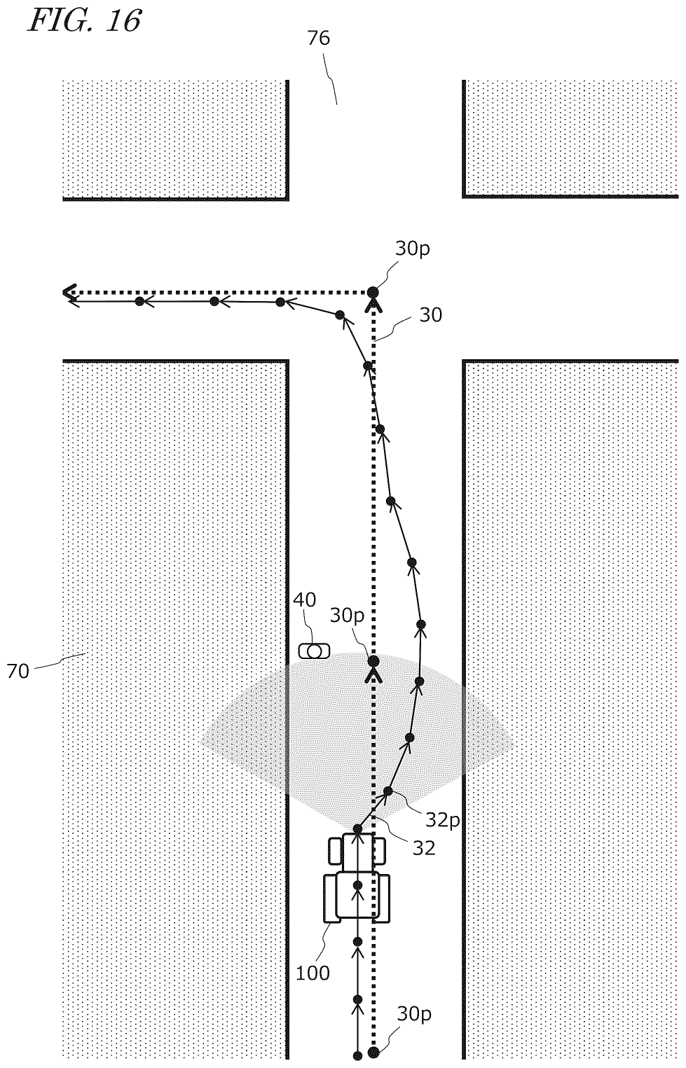

FIG. 16 is a diagram showing an example of a global path and a local path that are generated in an environment in which the obstacle exists. In FIG. 16, a global path 30 is illustrated with dotted arrows, wherein a local path 32 that is consecutively generated during travel is illustrated with solid arrows. The global path 30 is defined by a plurality of waypoints 30p. The local path 32 is defined by a plurality of waypoints 32p that is set in shorter intervals than are the waypoints 30p. Each waypoint has information of a position and an orientation, for example. By setting the plurality of waypoints 30p at a plurality of sites including an intersection between the roads 76, the management device 600 generates the global path 30. The interval between waypoints 30p is relatively long, e.g., on the order of several meters to several ten meters. During travel of the work vehicle 100, the ECU 185 sets the plurality of waypoints 32p based on sensor data that is output from the sensing devices, thus generating the local path 32. The interval between waypoints 32p in the local path 32 is shorter than the interval between waypoints 30p in the global path 30. The interval between waypoints 32p may be e.g. on the order of several ten centimeters (cm) to several meters (m). The local path 32 is generated in a relatively narrow range (e.g., on the order of several meters) starting from the position of the work vehicle 100. FIG. 16 shows a consecutive local path 32 generated while the work vehicle 100 travels along the roads 76 between the fields 70 and turns left at the intersection. During movement of the work vehicle 100, the ECU 185 repeats the operation of generating a local path up to a point that is e.g. several meters ahead of the position of the work vehicle 100 as estimated by the ECU 184. The work vehicle 100 travels along the local path as it is consecutively generated.

In the example shown in FIG. 16, an obstacle 40 (e.g., a person) exists ahead of the work vehicle 100. FIG. 16 illustrates an example of a range of sensing by the sensing devices such as the cameras 120, the obstacle sensors 130, or the LiDAR sensor 140 mounted on the work vehicle 100. In such a situation, the ECU 185 generates the local path 32 so as to avoid the obstacle 40 detected based on the sensor data. Based on the sensor data and the width of the work vehicle 100 (and, if an implement is attached, including also the width of the implement), the ECU 185 determines whether the work vehicle 100 may possibly collide with the obstacle 40, for example. If it is possible for the work vehicle 100 to collide with the obstacle 40, the ECU 185 generates the local path 32 by setting the plurality of waypoints 32p so as to avoid the obstacle 40. The ECU 185 recognizes not only the presence or absence of the obstacle 40, but also the road surface state (e.g., muddy, sunken, and so on) based on the sensor data, and if any site of traveling difficulty is detected, generates the local path 32 so as to avoid such a site. The work vehicle 100 travels along the local path 32. If the obstacle 40 cannot be avoided no matter how the local path 32 is set, the controller 180 may halt the work vehicle 100. At this time, the controller 180 may transmit an alert signal to the terminal device 400 to call attention of the supervisor. After halting, once it is recognized that the obstacle 40 has moved so that there is no fear of collision, the controller 180 may restart travel of the work vehicle 100.

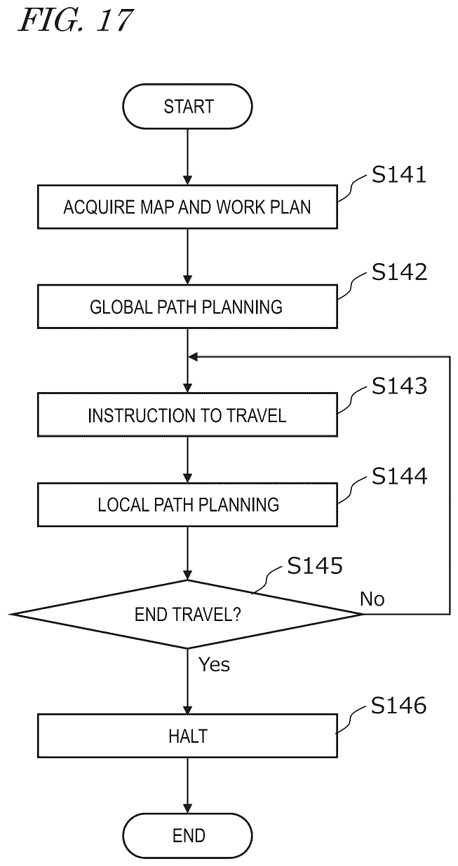

FIG. 17 is a flowchart showing an operation of path planning and travel control according to the present example embodiment. By performing the operation from steps S141 to S146 shown in FIG. 17, it is possible to perform path planning and to control self-traveling of the work vehicle 100.

In the example shown in FIG. 17, first, the management device 600 acquires a map and a work plan from the storage 650 (step S141). Next, based on the map and the work plan, the management device 600 performs global path planning for the work vehicle 100 with the aforementioned method (step S142). Global path planning can be performed at any timing before the work vehicle 100 begins traveling. The global path planning may be performed immediately before start of travel of the work vehicle 100, or any time before the previous day of the start of travel. The global path may be generated based on information (e.g., a departure point, a destination point, waypoints, and so on) that is input by the user via the terminal device 400. As described earlier, when generating a path to a field, or a path from a field to another place (e.g., a storage location or a standby location of the work vehicle 100), based on the attribute information of each road on the map, the management device 600 generates as a path for the work vehicle 100 at least one of a path that gives priority to agricultural roads, a path that gives priority to roads following along a particular geographic feature, or a path that gives priority to roads on which satellite signals can be properly received. The management device 600 transmits data representing the generated global path to the work vehicle 100. Thereafter, at a predetermined timing, the management device 600 gives an instruction for the work vehicle 100 to travel. Upon receiving this, the controller 180 of the work vehicle 100 controls the drive device 240 so as to begin travel of the work vehicle 100 (step S143). As a result of this, the work vehicle 100 begins traveling. The timing of start of travel may be set to any appropriate timing that allows the work vehicle 100 to arrive at the field by a scheduled start time of the first agricultural task on each work day as indicated by the work plan, for example. During travel of the work vehicle 100, with the aforementioned method, the ECU 185 of the controller 180 performs local path planning for avoiding collision with obstacles (step S144). If no obstacle is detected, the ECU 185 generates a local path essentially in parallel to the global path. Upon detection of an obstacle, the ECU 185 generates a local path that allows for avoiding the obstacle. Next, the ECU 184 determines whether or not to end travel of the work vehicle 100 (step S145). For example, if a local path that allow for avoiding the obstacle could not be generated, or if the work vehicle 100 has arrived at the destination point, the ECU 184 halts the work vehicle 100 (step S146). If no obstacle is detected, or if a local path that allows for avoiding the obstacle has been generated, control returns to step S143, and the ECU 184 causes the work vehicle 100 to travel along the generated local path. Thereafter, until it is determined at step S145 that travel is to be ended, the operation from steps S143 to S145 is repeated.

Through the above operation, the work vehicle 100 can automatically travel along the generated path, without colliding with obstacles.

In the example of FIG. 17, once generated, the global path is not changed until arrival at the destination. Without being limited to this example, the global path may be modified during travel of the work vehicle 100. For example, during travel of the work vehicle 100, based on sensor data that is acquired by the sensing devices such as the cameras 120 or the LiDAR sensor 140, the ECU 185 may recognize at least one of the state of the road being traveled by the work vehicle 100, the state of vegetation around the work vehicle 100, and the weather state, or if the recognized state satisfies a predetermined condition, the ECU 185 may change the global path. While the work vehicle 100 is traveling along the global path, some roads may be difficult to pass. For example, roads may be made muddy by torrential rains, the road surface may be sunken, or accidents or other causes may hinder passage. Alternatively, vegetation around the agricultural road may be more flourishing than expected, or a newly constructed building may make it difficult to receive satellite signals from the GNSS satellites. In consideration of such situations, the ECU 185 may detect roads that are difficult to pass based on sensor data acquired during travel of the work vehicle 100, and change the path so as to avoid any such road. Moreover, if the path has been changed, the ECU 185 may cause the changed path to be stored to the storage 170, and transmit the information of the changed path to the management device 600. In that case, the management device 600 may adopt the changed path when next time generating a path for the same field. This allows for flexible path planning that is adapted to the changing traveling environment.

The techniques according to example embodiments of the present disclosure are applicable to map data generation systems and path planning systems that generate map data for an agricultural machine to perform self-driving, e.g., a tractor, a harvester, a rice transplanter, a vehicle for crop management, a vegetable transplanter, a mower, a seeder, a spreader, or an agricultural robot, for example.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A map data generation system comprising:
a storage to store map data for an agricultural machine that performs self-driving; and
a processor configured or programmed to, when data of a road is not included in a predetermined region indicated by the map data, generate data of the road in the predetermined region based on:
a trajectory of a vehicle including a GNSS receiver and traveling in the predetermined region, the trajectory being acquired in the predetermined region based on GNSS data that is output from the GNSS receiver; and
attribute information of the vehicle.

2. The map data generation system of claim 1, wherein the processor is configured or programmed to:
when the attribute information of the vehicle includes information on a width of the vehicle, set a width of the road in the predetermined region to equal to or greater than the width of the vehicle.

3. The map data generation system of claim 1, wherein the processor is configured or programmed to:
when the attribute information of the vehicle includes information on a width of the vehicle and information as to whether the vehicle is an agricultural machine having an implement attached thereto or not, and the vehicle is an agricultural machine having an implement attached thereto, set a width of the road in the predetermined region to equal to or greater than a width of the implement.

4. The map data generation system of claim 2, wherein the processor is configured or programmed to:
when the attribute information of the vehicle includes information as to whether the vehicle is an agricultural machine or not, and the vehicle is an agricultural machine, set a category of the road in the predetermined region to agricultural road.

5. The map data generation system of claim 1, wherein the processor is configured or programmed to:
set an orientation of the vehicle in the predetermined region as an orientation of the road in the predetermined region, the orientation of the vehicle being acquired based on the trajectory of the vehicle at least in the predetermined region.

6. The map data generation system of claim 1, wherein the processor is configured or programmed to:
hold the generated road in the predetermined region and another road existing in the map data in association.

7. The map data generation system of claim 1, wherein the processor is configured or programmed to:
when the data of the road is included in the predetermined region, update the data of the road in the predetermined region based on:
a trajectory of a vehicle including a GNSS receiver and traveling in the predetermined region, the trajectory being acquired in the predetermined region based on GNSS data that is output from the GNSS receiver; and
attribute information of the vehicle.

8. The map data generation system of claim 7, wherein the processor is configured or programmed to, when the attribute information of the vehicle includes a width of the vehicle, and the width of the vehicle is greater than a width of the road in the predetermined region, update the width of the road in the predetermined region to the width of the vehicle.

9. The map data generation system of claim 7, wherein the processor is configured or programmed to, when the attribute information of the vehicle includes a type of the vehicle, the vehicle is an agricultural machine having an implement attached thereto, and a width of the implement is greater than a width of the road in the predetermined region, update the width of the road in the predetermined region to the width of the implement.

10. The map data generation system of claim 1, wherein the processor is configured or programmed to:
further acquire reception intensities of satellite signals by the GNSS receiver included in the vehicle when the trajectory of the vehicle in the predetermined region is acquired; and
when the reception intensities are higher than a predetermined intensity, generate or update data of the road in the predetermined region in the map data.

11. The map data generation system of claim 1, wherein the processor is configured or programmed to:
as the attribute information of the vehicle, acquire information on a width of the vehicle, information as to whether the vehicle has an implement attached thereto or not, and information on a width of the implement if the vehicle has an implement attached thereto;
when the vehicle has an implement attached thereto, set a width of the road in the predetermined region to equal to or greater than a width of the implement; and
when the vehicle does not have an implement attached thereto, set the width of the road in the predetermined region to equal to or greater than the width of the vehicle.

12. A path planning system comprising the map data generation system of claim 1, wherein
the processor is configured or programmed to generate a path for the agricultural machine that performs self-driving to travel outside fields by using data of the road in the predetermined region in the map data.

13. The path planning system of claim 12, wherein the processor is configured or programmed to:
generate the path by combining roads having a width which is equal to or less than a width of the agricultural machine.

14. The path planning system of claim 12, wherein the processor is configured or programmed to:
when the agricultural machine has an implement attached thereto, generate the path by combining roads having a width which is equal to or less than a width of the implement.
